(19) United States
(12) Patent Application Publication
(10) Pub. No.: US 2003/0062444 A1
(43) Pub. Date: Apr. 3, 2003

(54) Steam LTA craft and method of operation thereof

(76) Inventor: Thomas John Goodey, Brentford (GB)

Correspondence Address: THOMAS JOHN GOODEY, 86 WHITESTILE ROAD, BRENTFORD MIDDLESEX, ENG, TW8 9NL, GB

(21) Appl. No.: 10/241,377

(22) Filed: Sep. 8, 2002

Related U.S. Application Data
(62) Division of application No. 09/708,729, filed on Nov. 9, 2000.

(51) Int. Cl. B64B 1/00

(52) U.S. Cl. 244/24

(57) ABSTRACT

A lighter-than-air craft, which may be a freely floating balloon or may be an airship with its own propulsion, has an envelope which is filled with at least a substantial proportion of steam to provide buoyancy. Liquid water which accumulates at a low point of the interior of the envelope is passed out from the envelope and is discharged into the atmosphere, and stored ballast is also discharged into the atmosphere. The ballast discharge mass rate may be brought to be approximately equal to the water discharge mass rate, either manually or automatically; and the ballast discharge mass rate may be manually varied within a certain range around the water discharge mass rate. The ballast may be water. A drain valve may be provided for draining off liquid water as it condenses upon the inside of the envelope while preventing gas from escaping or entering, and a boiler may be provided for reboiling the drained off water into steam which is supplied back into the envelope. The rate of operation of this boiler may be variable, and a reservoir may be provided for temporarily storing water before it is reboiled.

### CROSS REFERENCE TO PARENT APPLICATION

This application is a division of U.S. patent application Ser. No. 09/708,729, which has matured as U.S. Pat. No. _____.

### FIELD OF THE INVENTION

This invention relates to a lighter than air craft—balloon or airship—in which steam is utilized as a principal component of the lift gas, and to a method of operation thereof.

### BACKGROUND OF THE INVENTION

The term “lighter than air craft”, hereinafter abbreviated herein as “LTA craft”, is in general use in reference to any aircraft for which a considerable proportion of its support in the atmosphere is provided, not by dynamic aerodynamic lift induced by motion relative to the air, but instead by buoyancy. This buoyancy is generated by a large and usually flexible container (the so called “envelope”) which is filled with a gas (the “lift gas”) whose density is substantially less than that of normal atmospheric air. Such LTA craft are termed “airships” when they are provided with means for propulsion through the atmosphere, or are termed “free balloons” when they are left to float freely in the atmosphere without any means for propulsion relative thereto.

In the prior art various lighter-than-air gases have been used as lift gases for filling the envelope of such a craft. Specifically, hydrogen, helium, methane, ammonia, and heated air have been utilized. Each of these lift gases has its advantages and disadvantages, which will now be discussed, bearing in mind that the effective molecular weight of air is about 29 (air being composed of approximately 80% N₂ with molecular weight of 28 and approximately 20% O₂ with molecular weight of 32, with some traces of CO₂ which is heavier and lesser traces of noble gases which are lighter) and that the mass of a cubic meter of air at the temperature (15° C.) and pressure (1013.2 mba) of the ISA (International Standard Atmosphere) at sea level is 1.225 kilograms, so that its weight is 12.02 newtons.

(1) Hydrogen as a Lift Gas

Hydrogen (H₂) was the first gas other than heated air to be used as a lift gas. It is cheap and easy to make, even in the field, and its molecular weight of 2 means that it offers superb lifting performance of 11.18 newton/m³ at sea level ISA, but it suffers from the great disadvantage of being very inflammable. Accordingly, although hydrogen was the mainstay for providing lift during the heyday of airships, nowadays hydrogen is no longer used in practice in airships as a lift gas, due to the risk of ignition from the propulsive means. Even for free balloons hydrogen is little used nowadays, again for reasons of safety.

(2) Helium as a Lift Gas

Almost all airships nowadays use helium (He) for lift. Helium has a (mono-) molecular weight of 4 and accordingly it provides 10.36 newton/m³ of lift at sea level ISA—almost as much as hydrogen—and it is completely safe because it is inert. However helium is so costly that it must be stringently conserved. The cost of a single fill of helium lift gas is nowadays a significant factor in the deployment of an airship. Furthermore, since helium is an inert element and does not form compounds, helium gas cannot be manufactured chemically from any solid or liquid precursor. Also the liquefaction of helium requires extremely low temperature. Accordingly it is difficult to provide helium in the field, since the only practicable way of handling it after production is to store it in a compressed state in cylinders which are expensive, heavy, and unwieldy.

(3) Methane as a Lift Gas

Methane (CH₄, or coal gas) has occasionally been used as lift gas. However methane is inflammable and offers no real safety advantage as compared with hydrogen, and its molecular weight of 16 means that it provides 5.39 newton/m³ of lift at sea level ISA—less than half the lift of hydrogen. Methane has no merit nowadays as a lift gas.

(4) Ammonia as a Lift Gas

Ammonia (NH₃) has been used as lift gas. Due to its molecular weight of 17 it provides lift of 4.97 newton/m³ at sea level ISA, i.e. rather less than half the lift of hydrogen, and it is substantially non-explosive. Furthermore it is quite easy to transport and supply in the field, because it can easily be liquefied under moderate pressure. Moreover, it is cheap. However ammonia is somewhat toxic and corrosive, as well as being malodorous, and accordingly it has not found great favor in practice as a lift gas.

(5) Heated Air as a Lift Gas

The density of heated air at ambient pressure is of course reduced from that of the surrounding air in proportion to the ratio between its absolute temperature and that of the surrounding air, and accordingly heated air can be used for providing lift for an LTA craft. If hot air is to be used, in practice, in order to maintain lift for any realistically long time period, this hot air must be continually reheated because it steadily cools down due to loss of heat through the envelope to the outside, and because its specific heat is quite low. The only practicable way of heating such a large volume of air (which always remains gaseous) is to project a flame from a gas burner directly into the envelope. As a very important additional beneficial feature, buoyancy control for the craft can be exerted simply and conveniently by varying the rate of this reheating. Hot air is very cheap and easy to produce in the field, and its use and production are reasonably safe. Free balloons lofted by hot air are extremely common nowadays, and hot air airships are also used. The chief disadvantage of hot air as a lifting gas, however, is the poor lift which it provides. In practice the average temperature of the hot air within the envelope varies between about 100° C. and about 120° C., i.e. between about 373K and about 393K, and 120° C. is typically the maximum operationally allowed lift air temperature. Since the outside air temperature at sea level ISA is 288K, this means that the lift provided by one cubic meter of hot air varies from about 2.74 newtons to about 3.21 newtons—about a quarter of the lift which would be provided by hydrogen. This means that the envelope required for lifting a given payload needs to be comparatively large.

In the case of an airship, a further serious disadvantage to the use of heated air as a lift gas is that, since typically the reheating method employed is to project the flame from a gas burner directly into the envelope, it is difficult or impossible to keep the envelope at positive pressure relative to the atmosphere. (Of course the upper portion of the envelope is at slight positive pressure relative to the atmosphere outside it, but its lower portion proximate to its downwardly facing open mouth is not). Accordingly, if as is typical the envelope is not supported by any rigid stiffening members, then the envelope is necessarily very floppy, and it is impossible to sustain any high speed through the atmosphere. Furthermore, the mounting of fins and the like to the envelope, and the suspension of a car therefrom, becomes difficult.

### SUMMARY OF PRIOR ART LIFT GAS PERFORMANCE

The advantages and disadvantages of these five prior art lift gases are summarized in the first six columns (i.e. in the non shaded portion) of the Table which is presented as FIG. 1A of the drawings; and the actual values of their density and of the lift which they provide are given in the first five rows of the Table which is presented as FIG. 1B of the drawings.

From the above it will be understood that in the actually practiced prior art no lift gas has been found to be ideal, and that in fact every lift gas used in the prior art has been subject to serious disadvantages of one type or another.

Envelope Pressure Management for Prior Art Airships

As mentioned above, a typical prior art airship in which heated air has been used as the lift gas has not been pressurized: its envelope has had an opening at its bottom, and the gas burner flame has been directed from below straight upwards into this opening in order to heat the air within the airship. As a result of not being positively pressurized, such a hot air airship does not function very satisfactorily, and its performance cannot be depended on, although it is marginally usable for particular purposes such as sport.

The envelopes of all other non-rigid or semi-rigid airships which have utilized other prior art lift gases have been closed and pressurized to somewhat above ambient pressure. (So-called rigid airships, in which the membranous bags containing the lift gas make no contribution to structural rigidity, will not be discussed or considered herein). With such a pressurized airship, if the pressure differential between the pressure within the envelope and the pressure of the outside atmosphere becomes too great, the envelope will be overstretched and may be damaged or even may burst, while if this pressure differential becomes too small, the envelope will lose its rigidity and will become floppy, which not only makes it impossible to sustain adequate speed through the atmosphere, but also threatens the maintenance of the physical shape of the envelope even when stationary, because the weight of the fins and the car and so on hanging upon the envelope may cause distortion.

Now, this pressure differential is subject to much disturbance. The greatest source of disturbance is that the external atmospheric pressure naturally varies as the airship changes altitude. However, disturbance of the pressure differential can also be caused by temperature-induced changes in the pressure of the lift gas due to variation in the amount of sunshine falling upon the envelope (so-called “insolation”), or due to change of the outside air temperature. Furthermore, significant change in the pressure of the external atmosphere due to weather conditions can progressively occur, and this also disturbs the pressure differential. Accordingly, the requirement has arisen to provide a means for adjusting the pressure level within such an airship envelope so as to keep the pressure differential at a suitable level for the current operational conditions.

With prior art lift gases other than heated air as described above, there has been no practical possibility of carrying a store of additional lift gas on board the airship for supply into the envelope when required due to a drop of pressure differential, and conversely there has been no practical possibility of removing some of the lift gas from the envelope and storing it when required due to a rise of pressure differential. In other words, if during flight the lift gas pressure inside the envelope starts to become insufficient, there has been no possibility of supplying further additional lift gas in order to remedy the problem; and, conversely, if during flight the lift gas pressure inside the envelope starts to become excessive, there has been no possibility of temporarily withdrawing some of the lift gas in order to remedy the problem (although of course simple venting of the lift gas, in a non-reversible fashion, has been possible). Accordingly the system which has been virtually universally adopted in the past for airship envelope pressure management has been to provide one or a plurality of ballonets within the envelope. Such ballonets are air bags which are pressurized with atmospheric air from outside the envelope by means of fans or other suitable devices. This pressurized air supply can be managed so as to expand or contract the ballonets in order to adjust the pressure differential.

However the provision of such ballonets and the provision of means for appropriately pressurizing them increases the initial cost of the airship. Moreover, during flight, managing the supply of pressurized air to these ballonets complicates the operation of the airship.

Lift Control for Prior Art Airships

Practical airships at the present time all use helium as lift gas, and this helium should not be vented except in emergency, due to cost considerations, and is of course at substantially ambient atmospheric pressure. This means that the gross lift of the airship (which is equal to the weight of the air displaced) is constant. The problem therefore arises that during flight the total weight of the airship inevitably reduces steadily, due to consumption of fuel. It might be thought that lightness of an aircraft can be nothing but beneficial, but in fact the airship soon becomes so light as to make its control in the vertical direction very difficult; and yet routine venting of helium cannot be seriously contemplated.

Various means have been tried to overcome this problem. In some sophisticated airships condensers have been provided for condensing water from the engine exhaust gases, and this can keep the weight of the airship approximately constant. However, such condensers are heavy and expensive. Some Zeppelins of the prewar years used to collect rainwater from the outside of the envelope during flight for ballast, and this expedient was helpful. Nowadays airships usually are ballasted for takeoff to as heavy a state as possible consistent with flight, and for a flight of short duration this often suffices. However, the problem remains. The lift of free balloons is sometimes varied by warming the lift gas as appropriate, and in this case the balloon is termed a “Roziere”. The present writer does not know of any case of this system actually being adopted for any powered airship (other than a hot air airship, of course).

The Concept of Steam as a Lift Gas

It has in the past been suggested to use steam—i.e. the vapor phase of water or H₂O— as a lift gas. The earliest such suggestion which the present inventor has been able to locate was a proposal by Cayley in 1815 relating to a powered airship. In U.S. Pat. Nos. 3,456,903, 3,897,032, and 4,032,085, Papst has also proposed various concepts relating to powered airships using steam lift gas. Moreover U.S. Pat. No. 5,890,676 to Coleman et. al. may also be considered relevant. It is not thought, however, that any of these proposals have resulted in actual hardware.

Furthermore, the present inventor has been informed by private verbal communication that in the past a Mr. Brian Boland has contemplated flying a manned free balloon, open to the atmosphere at the bottom, using steam as the lift gas. However the present inventor is unable to confirm the legal implications of this fact, since he does not know whether or not, or to what extent, this concept was published, nor exactly how far its implementation progressed, although it appears that it did not culminate in an actual flight.

Meanwhile, there is a per se known type of hot air free balloon in which the lift gas consists of warm (but not very hot) air with water vapor mixed therein up to the 100% humidity value. (The absolute amount of this water vapor is relatively modest.) The envelope is made of a black material—typically the cheap black polyethylene used for garbage bags—and the balloon is released on a sunny day. As the balloon rises and the hot air lift gas cools, dew forms on the inside of the envelope, and sunshine irradiating the outside of the black plastic material heats up this dew and revaporizes it, thereby transferring solar heat very efficiently to the lift gas and keeping it warm. The water vapor only contributes a very small amount of additional lift; its importance is for heat transfer. In French, the term “bulle d'orage” is used for this type of free balloon. Small such balloons equipped with radiosondes have attained quite impressive heights, but of course they only function during the daytime. It is not known whether any manned flight has been attempted.

The General Characteristics of Steam as a Lift Gas

The molecular weight of H₂O is 18, and therefore if a mass of steam were at sea level ISA temperature and pressure (which is of course impossible because in those conditions it would be in the liquid phase) it would provide lift of about 4.56 newton/m³. However in fact, at the pressure of the sea level ISA, steam needs to be maintained at a minimum temperature of 100° C., i.e. 373K, in order to remain in the gaseous phase. This implies that the lift which such steam provides in air which itself is at sea level ISA will be greater than the above in accordance with this higher steam temperature, and calculation in fact shows that the lift will be about 6.26 newton/m³. This is about 60% of the lift provided by helium and twice or more the lift provided by hot air (depending upon the overall temperature of the hot air).

Steam is substantially non-corrosive, and it is non-poisonous and possesses no odour. It cannot ignite, and it can be easily produced anywhere simply by boiling water. As for the question of cost, assuming that the available supply of water is at 10° C., then 90 kCal of heat is required to heat a kilogram of this water to 100° C. and a further 540 kCal is required to convert it into vapor (steam) still at 100° C.—a total of 630 kCal. A typical calorific value for fuel oil is 10,000 kCal/kg, and therefore, allowing for inefficiencies, the combustion of one kilogram of fuel oil will provide sufficient energy to produce about 10 kilograms of steam. Since fuel oil in quantity is quite cheap, it will be seen that the cost per kilogram of producing steam is very low.

The characteristics of steam as lift gas for an LTA craft are as summarized in the seventh column (shaded) of the Table of FIG. 1A; and the actual values of its density and of the lift which it provides are given in the sixth row of the Table of FIG. 1B.

Difficulties with Using Steam as a Lift Gas

Although based upon the above considerations steam seems quite promising as a lift gas both for free balloons and for airships, the main obstacle in practice to its use is that, as heat escapes through the envelope, the steam lift gas will naturally condense quite quickly into water, which will pour down the inside surface of the envelope. No serious attempt seems to have been made in any prior art proposal known to the present inventor to quantify the amount of this condensation by experiment, extrapolation or surmise, or to deal with its consequences. Despite the apparent advantages of using steam as a lift gas, therefore, no actual application has ever eventuated, nor has any proposal been put forward which includes complete and well-grounded figures and plans.

### OBJECTIVES OF THE INVENTION

Accordingly, it is an objective of this invention to provide an LTA craft using a lift gas at least mainly consisting of steam, and a method of operation thereof, which overcome the above described problems.

It is a further objective of this invention to provide an LTA craft furnished with a lift gas which has good lifting performance.

It is a further objective of this invention to provide an LTA craft furnished with a lift gas which is safe.

It is a further objective of this invention to provide an LTA craft furnished with a lift gas which is cheap.

It is a further objective of this invention to provide an LTA craft furnished with a lift gas which is easy to deploy in the field.

It is a further objective of this invention to provide an LTA craft furnished with a lift gas which is non-corrosive.

It is a further objective of this invention to provide an LTA craft furnished with a lift gas which is inoffensive.

It is a further objective of this invention to provide an LTA craft, the operation of which is economical.

It is a further objective of this invention to provide an LTA craft the lift of which is easy to control.

It is a further objective of this invention to provide such an LTA craft which is propelled by a simple and reliable propulsion means.

It is a further objective of this invention to provide such an LTA craft, the propulsive means of which is efficient.

It is a further objective of this invention to provide such an LTA craft which is propelled by the use of a cheap fuel.

It is a yet further objective of this invention to provide such an LTA craft which can easily be stored upon the ground.

It is a yet further objective of this invention to provide such an LTA craft which is quiet in operation.

It is a yet further objective of this invention to provide such an LTA craft which is environmentally friendly in operation.

It is a yet further objective of this invention to provide such an LTA craft, the propulsive means of which does not require frequent maintenance.

It is a yet further objective of this invention to provide such an LTA craft which is operated at positive pressure differential and the construction of which is simple.

It is a yet further objective of this invention to provide such an LTA craft which is operated at positive pressure differential and which is cheap to construct.

It is a yet further objective of this invention to provide such an LTA craft which is operated at positive pressure differential and which is simple to operate.

It is a yet further objective of this invention to provide such an LTA craft, for which during operation it is easy and simple to control the differential between the pressure within the envelope and the external atmospheric pressure.

### SUMMARY OF THE INVENTION

According to one aspect of the present invention, there is proposed a method for operating a lighter than air craft comprising an envelope which comprises an interior filled with a lift gas which contains a substantial proportion of steam, comprising processes of: passing liquid water accumulating at a low point of the interior of the envelope out from the envelope and discharging the passed out liquid water into the atmosphere; storing ballast; and discharging the ballast into the atmosphere. The ballast discharge mass rate may be brought to be, at each instant, approximately equal to the water discharge mass rate, either manually or automatically. In either case, the ballast discharge mass rate may be manually varied within a certain range around the water discharge mass rate. The ballast may desirably be water.

According to another aspect of the present invention, there is proposed a lighter than air craft comprising: an envelope which comprises an interior, which may be filled with a lift gas which contains a substantial proportion of steam; means for passing liquid water accumulating at a low point of the interior of the envelope out from the envelope and for discharging the passed out liquid water into the atmosphere; means for storing ballast; and means for discharging ballast from the storage means into the atmosphere. There may be further included means for, either manually or automatically, controlling the ballast discharge means so as to bring the ballast discharge mass rate to be, at each instant, approximately equal to the water discharge mass rate. And this ballast discharge control means may be further manually controllable so as to vary the ballast discharge mass rate within a certain range around the water discharge mass rate. The ballast may be water, in which case the ballast discharge means should be a water flow control valve.

According to yet another aspect of the present invention, there is proposed a lighter than air craft comprising: an envelope comprising an interior; and means for passing liquid water accumulating at a low point of the interior of the envelope out from the interior of the envelope, while intercepting gas from passing out from the interior of the envelope to the outside and intercepting gas from passing in from the outside to the interior of the envelope. This water passing and gas intercepting means may comprise a trap valve comprising a valve seat and a valve float, the valve float: when less than a predetermined level of liquid water is present around it, sinking therein and resting against and intercepting the valve seat and preventing the passage of liquid water and of gas through the valve seat; and, when more than the predetermined level of liquid water is present around it, floating upward therein and rising away from and opening the valve seat and allowing the passage of liquid water through the valve seat while the liquid water intercepts the passage of gas through the valve seat.

And, according to yet another aspect of the present invention, there is proposed a lighter than air craft, comprising: an envelope which comprises an interior; means for collecting liquid water accumulating at a low point of the interior of the envelope; and means for boiling the collected liquid water into steam and for supplying the steam into the envelope, whose rate of boiling operation is variable. There may further be included means for at least temporarily storing at least a portion of the accumulated liquid water, before supply thereof to the boiling means. Alternatively, there is proposed a lighter than air craft, comprising: an envelope which comprises an interior; means for collecting liquid water accumulating at a low point of the interior of the envelope; means for storing liquid water, which receives the liquid water from the water collecting means; and means for boiling liquid water from the water storing means into steam and for supplying the steam into the envelope, whose rate of boiling operation is variable. In use, the envelope should be filled with a lift gas which contains a substantial proportion of steam.

### BRIEF DESCRIPTION OF THE DRAWINGS

FIG. 1A is a table summarizing the characteristics of various lift gases;

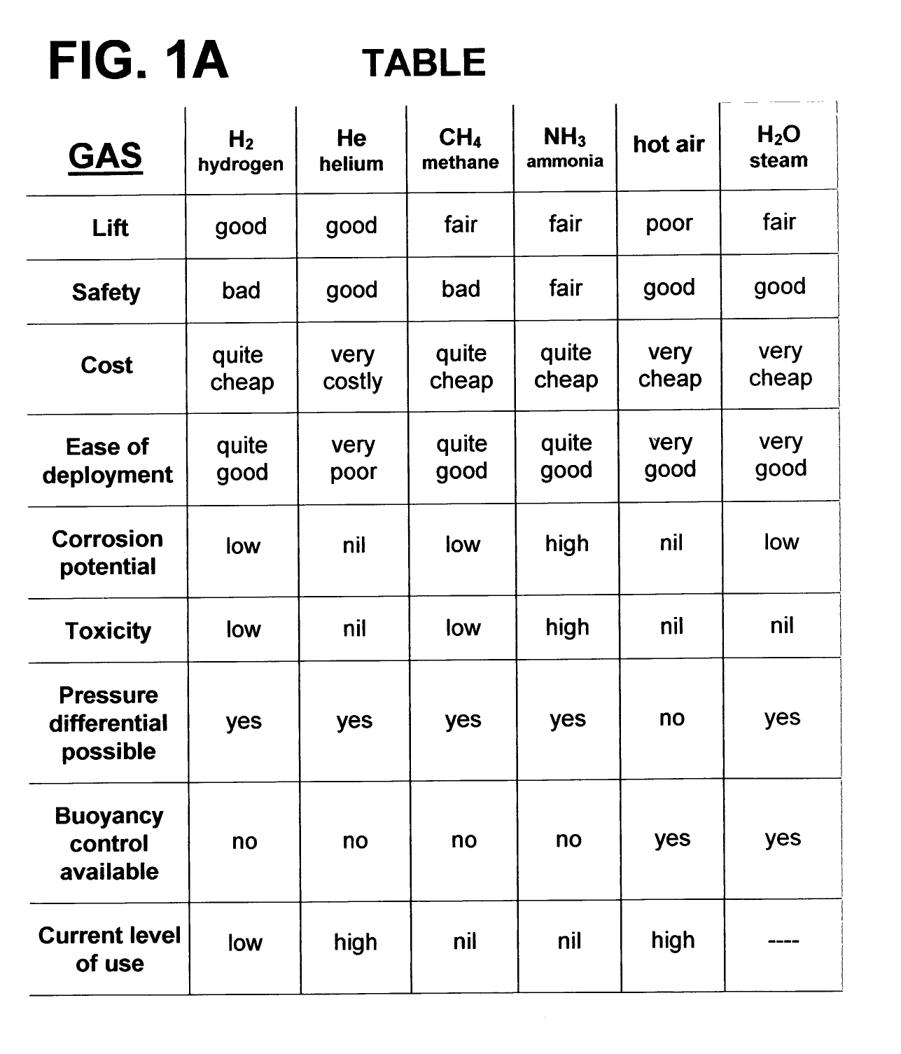

FIG. 1B is a table showing, in newtons per cubic meter, the actual densities and specific lifts of various lift gases at appropriate temperatures,;

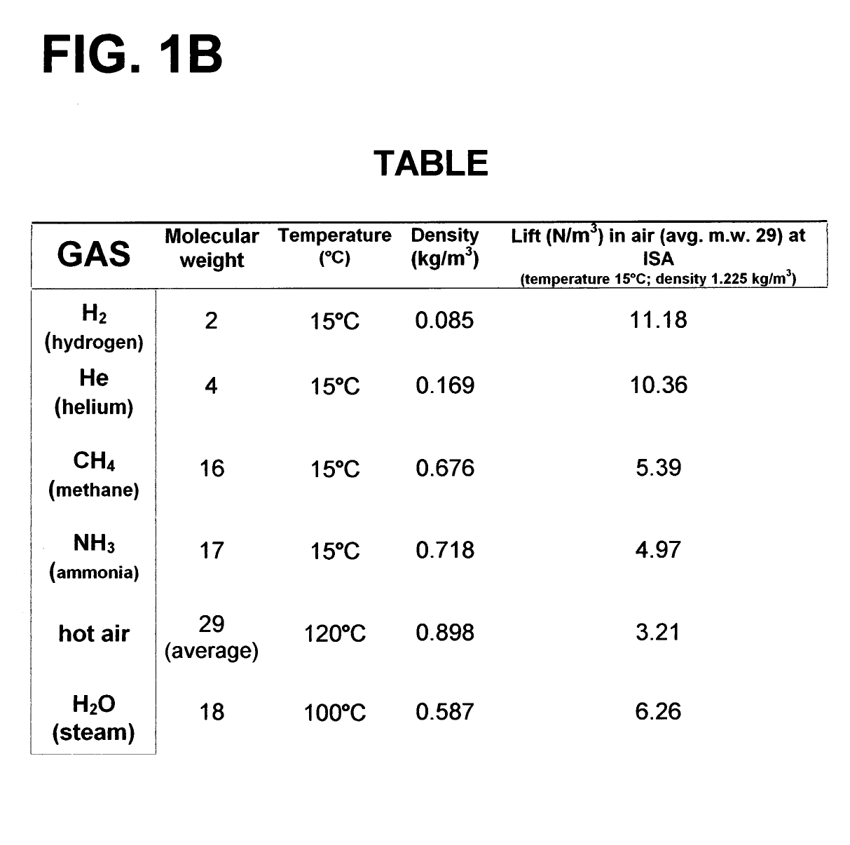

FIG. 2 is a schematic vertical sectional view of a free balloon which is a first preferred embodiment of the present invention, also schematically showing an envelope charging truck;

FIG. 3 is a schematic vertical sectional view similar to FIG. 2 for the first preferred embodiment, showing a free balloon which is a second preferred embodiment of the present invention, which incorporates a condensed water drain valve;

FIG. 4 is a schematic enlarged vertical sectional view of this condensed water drain valve;

FIGS. 5A and 5B are further schematic enlarged vertical sectional views similar to FIG. 4, showing the operation of this condensed water drain valve;

FIG. 6 is a schematic vertical sectional view similar to FIGS. 2 and 3, showing a free balloon according to a modification of the second preferred embodiment of the present invention, which additionally incorporates a ballast water release regulation valve;

FIG. 7 is a schematic enlarged vertical sectional view of this ballast water release regulation valve;

FIG. 8 is a schematic vertical sectional view similar to FIGS. 2 and 3, showing a free balloon which is a third preferred embodiment of the present invention, which incorporates a steam regeneration apparatus;

FIG. 9 is a schematic vertical sectional view similar to FIGS. 2, 3, and 8, showing a free balloon which is a fourth preferred embodiment of the present invention, whose envelope incorporates insulation;

FIG. 10 is a schematic vertical longitudinal sectional view, showing an airship which is a fifth preferred embodiment of the present invention, which is powered by an engine; and:

FIG. 11 is a schematic vertical longitudinal sectional view similar to FIG. 10, showing an airship which is a sixth preferred embodiment of the present invention, whose envelope incorporates no ballonets.

### DESCRIPTION OF THE PREFERRED EMBODIMENTS

The First Preferred Embodiment

Structure

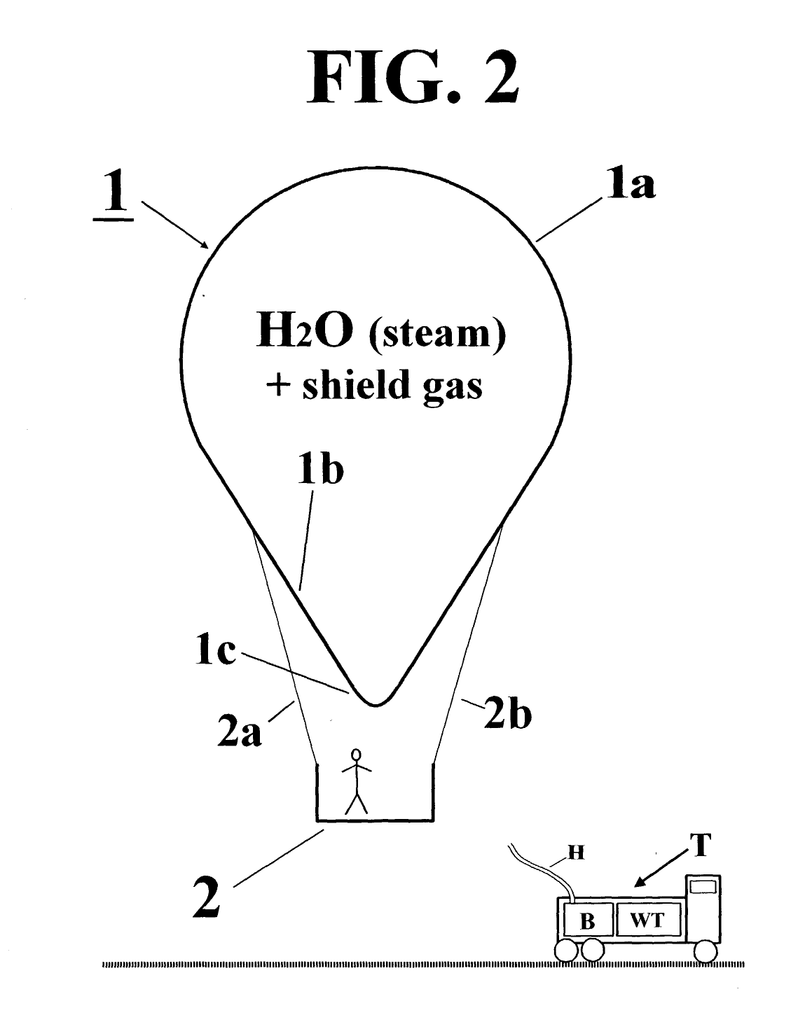

FIG. 2 is a schematic sectional view, taken in a vertical plane, showing the first preferred embodiment of the LTA craft of this invention, along with a charging truck therefor. This first preferred embodiment LTA craft is a free balloon whose envelope has a generally conventional shape, and its distinctive feature is that the lift gas which is utilized is principally steam, i.e. water (H₂O) which has been vaporized by heat, to which has been added a certain proportion of a so-called shield gas, which is particularly suitable for impeding loss of heat. The nature of this gas will be discussed hereinafter.

The balloon envelope is generally denoted by the reference numeral 1, and it comprises a globular upper portion 1a and a generally conical lower portion 1b which terminates in a pointed lower end portion 1c. A basket 2 is suspended below the envelope 1 by lines 2a and 2b. The envelope 1 is filled with steam (H₂O in its vapor phase) with a certain admixture of the shield gas.

Operation

This first preferred embodiment free balloon is operated as will now be described.

For initial inflation on the ground from the collapsed condition there is provided a steam truck T, which is equipped with a water tank WT, a high capacity boiler system B, and a steam supply hose H. To inflate this balloon, the hose H is connected to a suitable connector (not shown in the figure) provided upon so the envelope 1 as to communicate with the envelope interior, and then the boiler B is operated to boil water from the water tank WT, the resulting steam being supplied through the hose H into the envelope 1. When the envelope 1 is appropriately charged with steam, or during the charging process, a suitable amount of the shield gas is added, and then this balloon may be released to commence flight, of course leaving the steam truck T on the ground.

Optionally the envelope 1 may not be completely filled upon takeoff, so that some additional room remains still available within it. In such a case, of course, the pressure within the envelope 1 (at the base thereof) will not be elevated above atmospheric. In any case there is no reason to operate this first preferred embodiment LTA craft at positive pressure, since it is a balloon and there is no question of it moving relative to the air in which it floats (apart from ascending and descending), and accordingly the envelope 1 is not required to be distended with positive pressure in order to provide rigidity.

As soon as steam is supplied into the envelope 1, heat inevitably starts to pass from this steam to the outside atmosphere through the material of the envelope, and accordingly water droplets will start condensing upon the inner envelope surface. These liquid water droplets will soon start trickling downwards to the lowest point of the envelope 1, i.e. downwards to the pointed lower end envelope portion 1c. Thus liquid water at a temperature of substantially 100° C. will start accumulating in this pointed lower end portion 1c, and in this first preferred embodiment this liquid water will continue thus to accumulate. Moreover, in some operational circumstances, some of the steam within the envelope 1 may condense into floating liquid water droplets which do not immediately settle upon the inner envelope surface, but which remain as a sort of mist within the interior space of the envelope 1. With this first preferred embodiment the duration of flight will inevitably be limited, since no means are provided for maintaining the temperature of the steam within the envelope 1. However, the shield gas which is mixed into the lift gas substantially reduces the rate of heat loss, as will be described hereinafter, and accordingly prolongs the maximum possible duration of flight.

The advantages and disadvantages of this first preferred embodiment free balloon which uses steam mixed with shield gas as lift gas are as follows.

Comparison with Hydrogen and Helium Balloons

The lifting performance provided by the lift gas used in this balloon is only about 60% that of hydrogen or helium (the quantity of the shield gas is so small that it may be ignored in this connection), so that the present invention is markedly inferior in this regard. Moreover the duration of flight is limited by cooling down of the lift gas. However, this balloon avoids the excessive danger of hydrogen and the excessive cost of helium. Yet further, the great difficulty of providing helium in the field is completely eliminated, since in fact steam is even easier to produce locally than hydrogen, and only a small amount of the shield gas is required.

Comparison with Heated Air Balloons

Actually hydrogen and helium balloons are little used nowadays, and for a free balloon the really significant comparison must be with heated air. In order to focus the discussion, the case will be considered of a balloon according to this first preferred embodiment whose envelope has a radius of 10 m, so that its volume (including the conical lower portion 1b) is about 4,500 m³ and its surface area is about 1,300 m². This balloon is similar, for example, to the balloon model N140 currently being marketed by Cameron Balloons, which has a volume of about 3970 m³.

In the conventional case of using heated air as the lift gas, as explained above, the maximum gross lift available even at the highest operationally acceptable lift air temperature of 120° C. will be about 14,355 newtons, so that the maximum gross mass that can be flown will be about 1,460 kg. In fact, usually the lift will be lower than this value, since this maximum lift air temperature of 120° C. is an extreme which is rarely attained in practice throughout the entire envelope. On the other hand, with the use of steam as the lift gas, the gross lift is virtually doubled to about 28,170 newtons, which can fly a gross mass of about 2,870 kg. This is a great enhancement over the conventional art.

Moreover, with regard to the duration of flight, the temperature inside the envelope of this steam balloon is a uniform 100° C., and at sea level ISA the temperature of the outside air is 15° C., so that the temperature differential between the inside and outside of the envelope is about 85° C. On the other hand, in the case of a similarly sized conventional balloon which uses heated air as the lift gas, as described above the average temperature within the envelope needs to be at the maximum rated value of 120° C. even to obtain half the gross lift of this first preferred embodiment balloon, so that the temperature differential is about 105° C. Clearly, therefore, the rate of loss of heat in the case of the present invention will be substantially less than in the comparison case when heated air is used as the lift gas. Accordingly the duration of flight will be correspondingly prolonged. Furthermore the admixture of the shield gas into the steam lift gas further substantially reduces the rate of loss of heat.

A Note Upon Safety of a Free Steam Balloon

Steam presents no substantial safety problem while the balloon envelope is being charged and during flight. However during landing, during the critical time period from just before to just after the instant at which the basket 2 impacts the ground, it will naturally be necessary to rip the envelope to release all the lift gas which it contains. Now releasing such a large quantity of steam in close proximity to the pilot and other personnel in the balloon basket might present a risk of scalding, because of the great latent heat of steam. However in the case of a free balloon this risk is not great, because typically during landing the basket impacts the ground first, and the envelope subsequently settles downwind. In the case of the free steam balloon described above, it may be judged desirable for the basket suspension lines 2a and 2b to be made somewhat longer than in the case of a conventional hot air balloon, in order to ensure, as the envelope 1 settles to the ground and discharges its steam lift gas contents, that the basket 2 is kept well away from the pilot and passengers.

The Shield Gas

The present inventor bases his opinion that an admixture of an appropriate shield gas can be effective for reducing the heat loss from a vessel filled with steam upon the following passage from “The Efficient Use of Steam”, by Oliver Lyle, HMSO, 1947, p. 294:

“Very little information seems to be available upon the actual effect of air in steam on actual Heat Transfer Rates. Some results published by the American Institute of Chemical Engineers in 1935 gave the following effects for air on the Heat Transfer Rate of the steam side only:

| | PerCent. |
|---|---|
| PerCent. Air | H.T.R. Steam |
| by Weight | side only |
| 0 | 100 |
| 0.5 | 87 |
| 1.0 | 76 |
| 1.5 | 71 |
| 2.0 | 69 |
| 2.5 | 68 |
| 3.0 | 67 |

If these figures are right it means that it is of the utmost importance that the last trace of air be removed.”

This passage is written from the point of view of maximizing heat transfer through a heating surface such as a boiling pan; but it suggests that admixture of a modest proportion of air into the steam lift gas of a steam balloon may be effective for minimizing heat loss to the atmosphere.

Moreover, the present inventor has conceived of the idea of using a gas other than air as a shield gas. The physical happenings which give rise to this heat-barrier shielding effect are obscure at the present time; presumably a layer of or enriched in the shield gas forms next to the inner surface of the envelope, and impedes steam condensation thereon. However it is presumed that, in general, a gas which has low thermal conductivity will be more effective than one which has high thermal conductivity.

Therefore it is considered that the following gases will be effective as shield gases (thermal conductivities at 400° K in mW/m.°K shown in parentheses):

Xenon (7.3); krypton (12.3); argon (22.6); sulfur dioxide (14.3); n-hexane (23.4); and chloroform (11.1).

(By comparison, the thermal conductivity of air at 400° K is 33.3, in these units.)

As far as non-elemental gases are concerned, it appears that generally the thermal conductivity drops as the molecular weight increases. Accordingly it is considered that any substance which is gaseous at 100° C. and atmospheric pressure and which has a relatively high molecular weight is a good candidate for use as shield gas. Furthermore, it will be beneficial for the shield gas substance also to be gaseous at about 15° C. and atmospheric pressure, in order for it to evaporate from the envelope material after flight and subsequent deflation. It is considered that there will be little advantage in increasing the weight proportion of the shield gas above about 5%.

This concept of mixing in a shield gas with the steam lift gas can be applied to any of the embodiments of the present invention described hereinafter, and in each case will provide an additional benefit.

The Second Preferred Embodiment

Structure

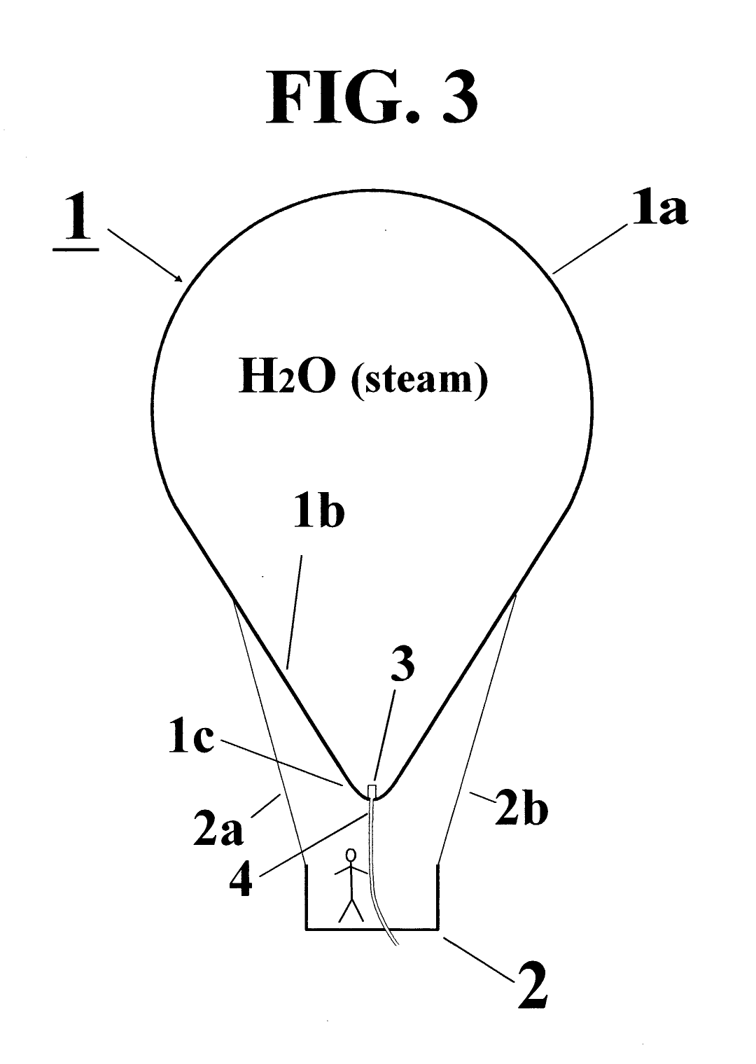

FIG. 3 is a schematic sectional view similar to FIG. 2 for the first preferred embodiment, showing a free balloon which is a second preferred embodiment of the present invention. In this figure, elements of the second preferred embodiment which correspond to elements of the first preferred embodiment shown in FIG. 2 and which have the same functions are denoted by the same reference symbols, and the explanation of this second preferred embodiment will focus chiefly upon the features in which it differs from the first preferred embodiment described above, thus omitting repetitive matter. In this case, a condensed water drain valve 3 is provided at the bottom of the pointed lower end portion 1c of the envelope 1, and the upper end of a condensed water drain hose 4 passes through the envelope 1 and is connected to this drain valve 3. Thus, the condensed water drain valve 3 controls the communication between the condensed water drain hose 4 and the interior of the envelope 1. In this second preferred embodiment the lower end of the drain hose 4 is left open to the atmosphere below the basket 2.

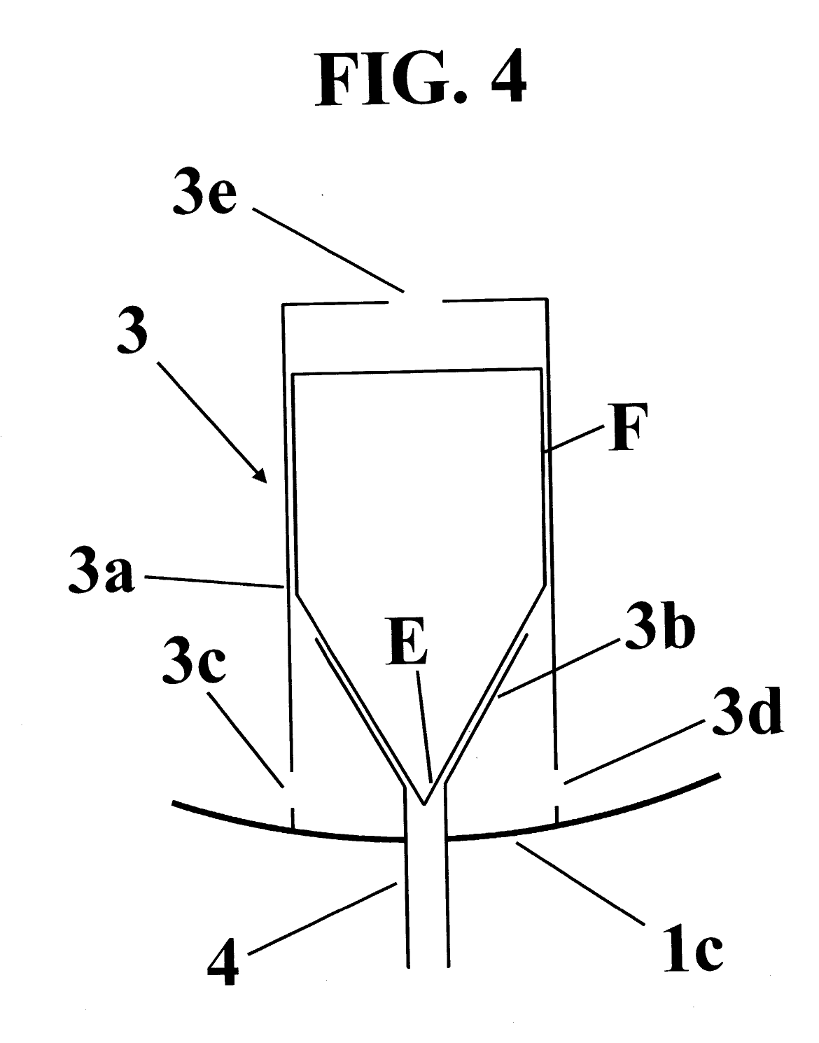

A construction for the condensed water drain valve 3 is shown in FIG. 4, which is a schematic enlarged sectional view thereof. This drain valve 3 is fixed upon the inside upper surface of the pointed lower end envelope portion 1c, and comprises a generally hollow cylindrical body 3a within which is slidably received a float F, which is shaped as generally cylindrical with a pointed lower end E, and whose density, at 100° C., is somewhat less than that of water. The upper end of the condensed water drain hose 4 projects inside the valve body 3a and is provided with a conical seat 3b which faces upwards and which receives the downwardly pointing lower pointed end E of the float F. Fill holes 3c and 3d for allowing the passage of fluid are pierced through the lower portion of the hollow cylindrical body 3a of the valve 3, at a level lower than that of the top edge of the conical seat 3b, and a vent hole 3e is pierced through the upper end face of the body 3a for venting.

Operation of this Condensed Water Drain Valve

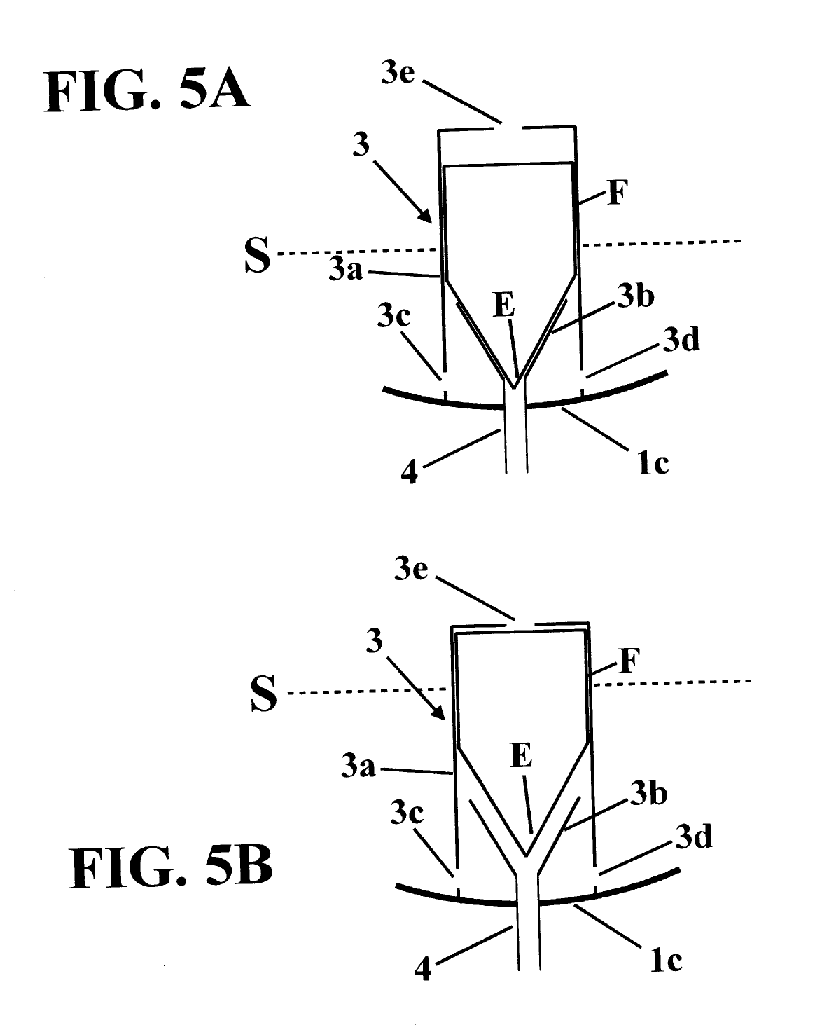

When the envelope 1 is filled with steam, this drain valve 3 functions as will now be described with reference to FIG. 5, which consists of two schematic enlarged sectional views similar to FIG. 4. Due to heat loss through the material of the envelope 1 to the outside atmosphere, water droplets will condense out from the steam within the envelope 1 upon the inner envelope surface, and some of these droplets will trickle downwards and will accumulate as liquid water at a temperature of substantially 100° C. in the pointed lower end portion 1c of the envelope 1. While the level S of the surface of this accumulated water mass remains lower than a critical level which will cause the float F to float, then as shown in FIG. 5A the pointed lower end E of the float F will remain seated in the conical seat 3b and will close off the upper end of the hose 4 so as to interrupt communication between the hose 4 and the interior of the envelope 1. In this condition, there is no possibility that either any of the accumulated water in the pointed lower end envelope portion 1c or any of the gaseous steam within the envelope 1 should pass downwards through the hose 4. On the other hand, when the level of the surface S of the accumulated liquid water mass in the pointed lower end portion 1c of the envelope 1 rises above the critical level and causes the float F to float, then as shown in FIG. 5B the pointed lower end E of the float F rises out of the conical seat 3b and opens up the seat 3b so as to communicate the hose 4 with the interior of the envelope 1 via the holes 3c and 3d. In this condition, the level of the surface S of the accumulated water mass is definitely higher than the top of the conical seat 3b, so there is no danger that any of the steam from within the envelope 1 should escape downwards through the hose 4; on the contrary, only liquid water from the accumulated liquid water mass in the pointed lower end portion 1c of the envelope 1 is allowed to pass downwards through the hose 4, from which it is discharged. As a result, it is seen that the valve 3 according to this construction allows accumulated liquid water in the lower portion of the envelope 1 to be drained out therefrom, while reliably preventing any of the steam in the interior of the envelope 1 from escaping via this path.

The consequence of the provision of this condensed water drain valve 3 in this second preferred embodiment of the present invention is to substantially prolong flight time, as compared with a hypothetical comparison steam balloon in which the condensed water is accumulated in the bottom portion of the envelope, for the following reasons.

Let the characteristic time period required for 540 kCal of heat to pass through the material of the envelope 1, both in the case of the balloon according to the second preferred embodiment described above and in this case of the comparison steam balloon, be P seconds; this time period P will depend only upon the temperature of the external atmosphere, since the temperature inside the envelope 1 is in both cases a uniform 100° C. because it contains both water and steam in mutual thermodynamic equilibrium. This heat loss will cause 1 kg of steam, whose volume is 1.70 m³ at sea level ISA, to condense into liquid water of only 0.001 m³ volume, which is negligible. Accordingly in both cases the loss of gross lift will be 20.47 newtons. However in the case of the comparison steam balloon the resulting one kilogram of condensed water is retained within the envelope in a growing water pool in its lower end portion, and accordingly the weight of this water pool, which is a useless parasitic load, will increase by 9.81 newtons. In the case of this comparison steam balloon, therefore, the loss of net lift is 20.47 newtons per P seconds, while in the case of the second preferred embodiment described above the loss of net lift is only 10.66 newtons per P seconds, because the useless water condensed within the envelope 1 is continually drained via the valve 3 and the hose 4 downwards and is discharged from the balloon. Accordingly the time of flight will be correspondingly prolonged—in fact, approximately doubled.

Ballast Compensation and Operation of this Balloon

In general, a manned free balloon is never released or flown with much excess lift, because it would rise uncontrollably. Excluding the case of hot air balloons to which the present discussion does not apply, at launch, a suitable amount of ballast (either water or sand is typically used) is taken aboard to reduce the net lift to a low but positive value. The balloon is then released and rises at an acceptable and controllable speed. The ballast is subsequently discharged as appropriate in order to perform vertical manoevering.

In the case of this free balloon according to the second preferred embodiment, ballast needs to be continually discharged in order to maintain flight, since the lift will decrease by 10.66 newtons (1.09 kg weight) during each above defined characteristic time period P. In fact, if the balloon is weighed off with W kg of ballast at launch so as to be marginally buoyant, then flight can be maintained for a maximum of (W/1.09)×P seconds. And vertical control can be exerted very simply and powerfully by varying the rate of ballast discharge. (The arrangements for such ballast discharge are not shown in FIG. 3 because they may be per se conventional.)

A Variant Embodiment Including an Automatic Ballast Release Device

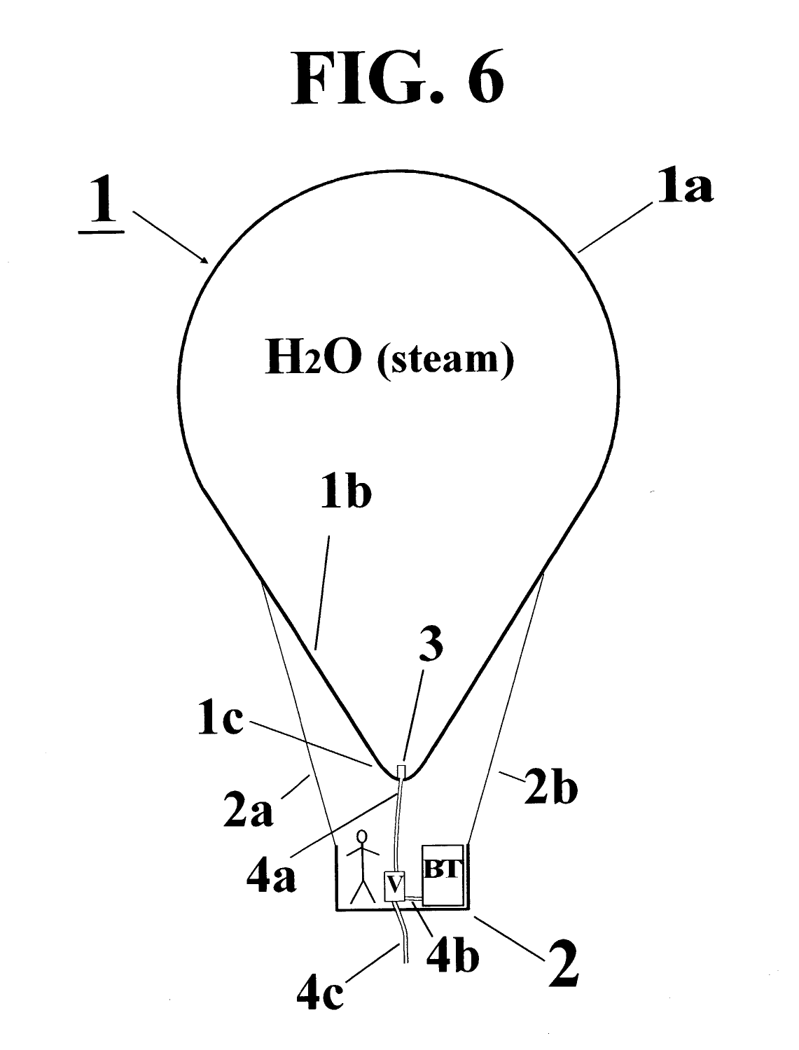

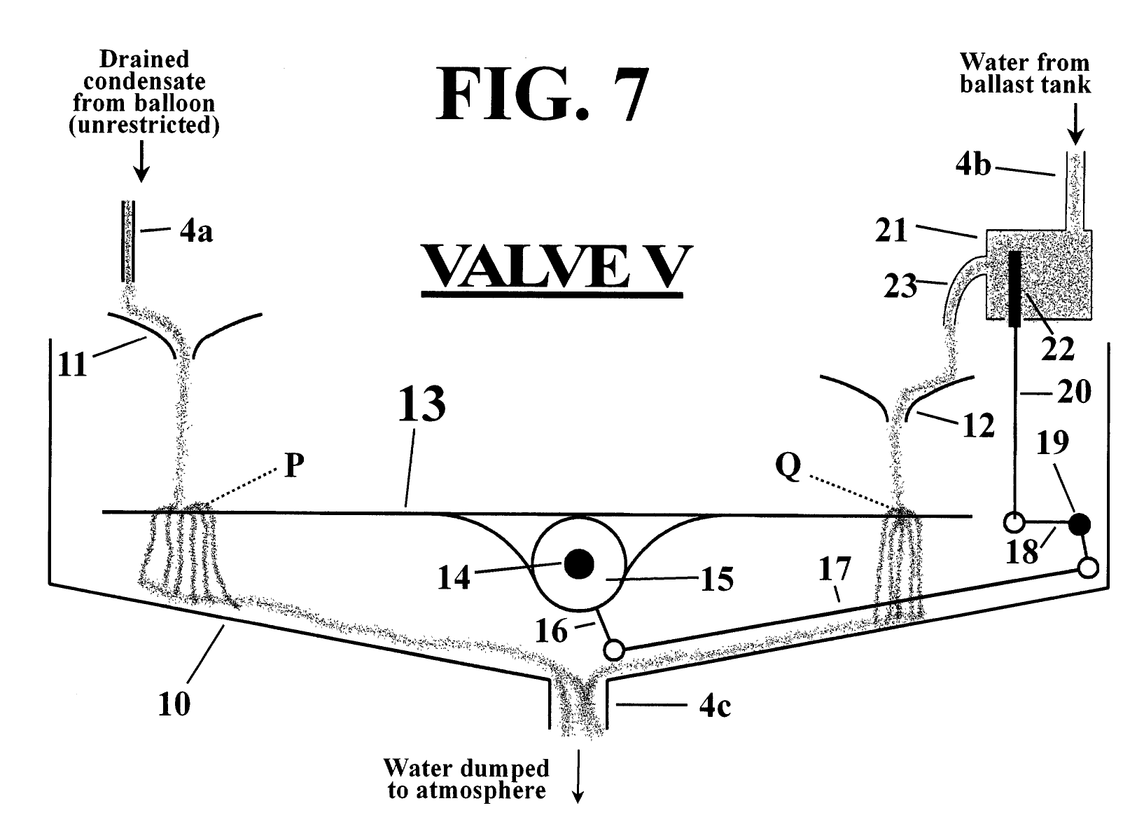

A modification shown in FIGS. 6 and 7 takes advantage of the fact explained above that, during the flight of the above described balloon according to the second preferred embodiment, the rate of ballast discharge (1.09 kg in P seconds) which must be maintained for continuous level flight is almost equal to the rate of discharge (1 kg in P seconds) of water condensed from the steam lift gas to the atmosphere via the condensed water drain hose 4 of FIG. 3.

Thus, FIG. 6 is a schematic vertical sectional view similar to FIGS. 2 and 3, showing a free balloon according to this variant embodiment, which additionally incorporates a ballast water release regulation valve V. The flow of condensed water which is drained through the valve 3 from the envelope 1 is supplied to one inlet of this valve V through a condensate drain hose 4a. And a flow of ballast water from a ballast tank BT is supplied to another inlet of this valve V through a ballast tank connection hose 4b. The function of the regulation valve V is to regulate the flow of ballast water so as to keep it approximately equal to this condensate drainage flow, while not impeding the aforesaid condensate drainage flow. The conjoined flows of ballast water and drained condensate water are discharged from the balloon through a water drain hose 4c.

FIG. 7 is a schematic enlarged vertical sectional view showing one possible construction for this ballast water release regulation valve V; various other possible ways of embodying this valve V will be apparent to a person of ordinary skill in the relevant art without undue experimentation, based upon the disclosure in the present specification. An arm 13 extends generally horizontally within a body 10 of this valve V, and is pivoted near its center portion at a pivot point 14. A rotational damper 15 damps rotation of this arm 13 around the pivot point 14 over the short term, but does not substantially impede the rotation of the arm 13 over the long term. The flow of condensate water drained from the envelope 1 through the condensate drain hose 4a pours into a first funnel 11 so as to break the impact of its fall, and then pours from the first funnel 11 to impact onto one side of the arm 13 in the vicinity of a point P. Then the condensed water flow falls off the arm 13 and is collected by the bottom of the valve body 10 to flow out therefrom through the water drain hose 4c.

Meanwhile, a flow of ballast water from the ballast tank BT through the connection hose 4b passes through a control valve 21 which regulates its flow amount and will be described hereinafter, then pours from an output conduit 23 of this valve 21 into a second funnel 12 so as to break the impact of its fall, and then pours from the second funnel 12 to impact onto the other side of the arm 13 in the vicinity of a point Q. Then this ballast water flow falls off the arm 13 and is collected by the bottom of the valve body 10 to flow out therefrom through the water drain hose 4c, together with the condensate water flow described above.

The heights of the funnels 11 and 12, and the distances of the points P and Q from the arm pivot point 14 (which may be adjustable) are so chosen that the arm 13 is at equilibrium (is not subject to any net torque) when the flow of condensate water from the first funnel 11 is approximately equal in volume to the flow of ballast water from the second funnel 12. Further, the rotation of the arm 13 is transmitted to a crank 16 which actuates a first link rod 17 to turn a crank 18 which is pivoted at a pivot point 19, so as to pull or push upon a second link rod 20 which opens or closes a gate 22 of the control valve 21, thus regulating the flow of ballast water.

Starting from the above described equilibrium state, if (for example) due to increase in the volume of the flow of condensate water the pressure upon the arm 13 at the point P increases, then the arm 13 and the crank 16 will rotate counterclockwise in the figure, so as to push upon the rod 17 and rotate the crank 18 counterclockwise, thus pulling upon the rod 20 and opening the valve gate 22 somewhat. This increases the flow of ballast water until it matches the flow of condensate water. At this point the rotation of the arm 13 stops at a new equilibrium point. Morever, if the flow of condensate water decreases, then the converse action to the above occurs. Thus the overall action of this valve V is to regulate the flow of ballast water so as to keep it approximately equal to the condensate drainage flow, without restricting the condensate drainage flow. The rotational damper 15 is provided to prevent the system hunting.

Operation of this Variant Embodiment

The main portion of the ballast water discharge required to keep this balloon in steady flight is taken care of by the automatic valve described above. However the pilot will inevitably be required to monitor the rate of ballast water discharge and to make smaller-scale modifications as required from time to time. He may do this either by shifting one or both of the funnels 11 and 12, or by an independent means of ballast discharge, or by biasing the gate 22 of the valve 21 (or the arm 13), as appropriate.

The Third Preferred Embodiment

Structure

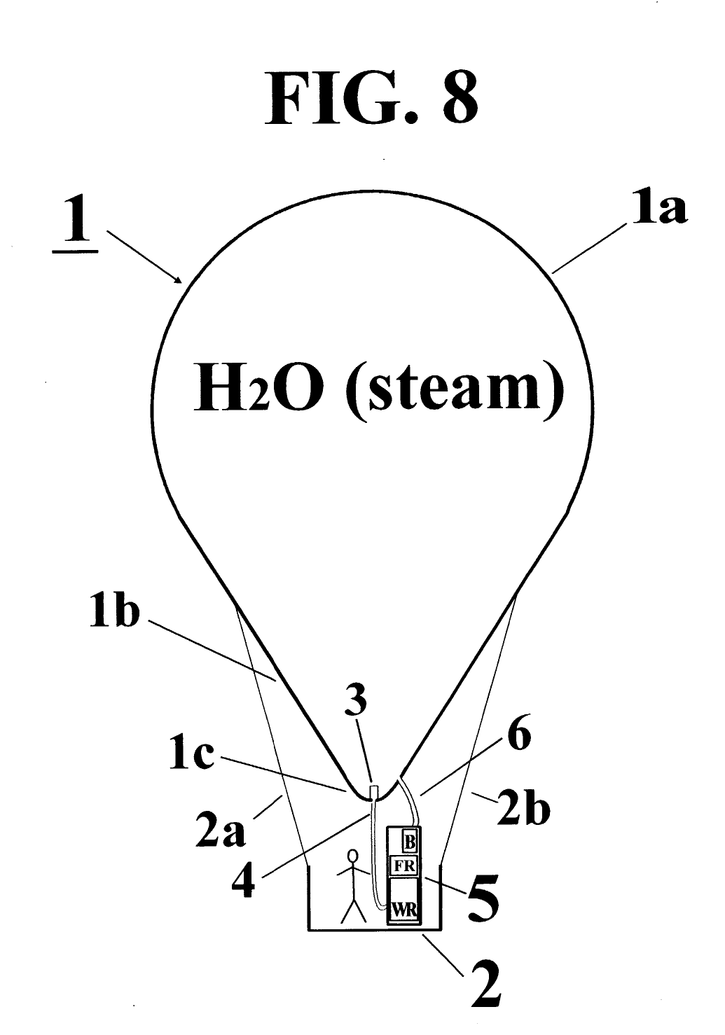

FIG. 8 is a schematic sectional view similar to FIGS. 2, 3, and 6, showing a free balloon which is a third preferred embodiment of the present invention. In this figure, elements of the third preferred embodiment which correspond to elements of the first and second preferred embodiments shown in FIGS. 2 through 5 and which have the same functions are denoted by the same reference symbols, and the explanation of this third preferred embodiment will focus chiefly upon the features in which it differs from the first and second preferred embodiments described above, thus omitting repetitive matter. The distinctive feature of this third preferred embodiment is that the steam lift gas is continually regenerated by the condensed water being reboiled.

In this third preferred embodiment, in substantially the same manner as in the second preferred embodiment described above, a condensed water drain valve 3 is provided at the bottom of the pointed lower end portion 1c of the envelope 1, and the upper end of a condensed water drain hose 4 is connected to this drain valve 3. However, in this third preferred embodiment, the lower end of the drain hose 4 is connected to and discharges drained water into a steam regeneration apparatus 5. This steam regeneration apparatus 5 is also communicated to the envelope 1 by a steam supply hose 6, which passes through the conical envelope portion 1b at a position somewhat higher than the pointed lower end envelope portion 1c and opens within the envelope 1.

The steam regeneration apparatus 5 may conveniently be powered by combustion of a fossil fuel such as fuel oil, coal, or coke (although in principle it could be nuclear powered), and it comprises a water reservoir WR, a fuel reservoir FR, a boiler B which comprises a burner not particularly shown, and ignition apparatus, control apparatus and the like none of which are particularly shown either. Various methods of embodying these components and their interactions will be evident to a person of ordinary skill in the relevant art without undue experimentation, based upon the functional descriptions in this specification. The function of the steam regeneration apparatus 5 is to receive condensed liquid water from within the pointed lower end envelope portion 1c via the drain hose 4, to accumulate a quantity of this liquid water in the water reservoir WR if the operator deems doing so is advantageous, and to boil water from this reservoir WR at a desired and variable rate using the boiler B to produce steam, which is then supplied into the envelope 1 via the steam supply hose 6 at a pressure equal to or slightly greater than the external atmospheric pressure.

Operation

For initial inflation on the ground from the collapsed condition it is not contemplated that the boiler B in the steam regeneration apparatus 5 will ordinarily be used, both because its boiling capacity will probably not be fully adequate for such a task, and also because it is desirable for this boiler B to be reserved only for use for water that has already been conditioned, i.e. has already been boiled and recondensed so that it has been purged of dissolved solids. Instead, steam for initial ground inflation of the envelope 1 will typically be provided from an external steam supply means (not particularly shown) like the steam truck T described above with regard to the operation of the first preferred embodiment. Optionally, some reserve water may be stored in the water reservoir WR before takeoff. As with the first preferred embodiment, optionally the envelope 1 may not be completely filled upon takeoff, so that some additional room remains still available within it. In any case, when the envelope 1 is appropriately charged with steam, this third preferred embodiment free balloon may be released to commence flight, of course leaving the steam truck T on the ground.

As soon as steam is supplied into the envelope 1, heat inevitably starts to pass from this steam to the outside atmosphere through the material of the envelope, and accordingly water droplets will start condensing upon the inner envelope surface. These liquid water droplets will soon start trickling downwards to the lowest point of the envelope 1, i.e. downwards to the pointed lower end envelope portion 1c. Thus liquid water at a temperature of substantially 100° C. will start accumulating in this pointed lower end portion 1c, and this hot water will drain via the condensed water drain valve 3 and the drain hose 4 into the water reservoir WR of the steam regeneration apparatus 5.

In this third preferred embodiment balloon, this drained water in the reservoir WR is reboiled in order to maintain lift. The operator does this by operating the boiler B, which combusts an appropriate amount of fuel from the fuel reservoir FR to convert the desired amount of water from the reservoir WR into steam. This steam is supplied via the steam supply hose 6 back to the interior space within the envelope 1.

Now, in some circumstances some of the steam within the envelope 1 may condense into floating liquid water droplets which do not immediately settle upon the inner envelope surface, but which remain as a sort of mist within the interior space of the envelope 1. In order to reconvert these floating liquid water droplets into steam, it may in some circumstances be advantageous for the operator so to control the steam regeneration apparatus 5 as to supply steam to within the envelope 1 at a temperature higher than the boiling point of water at the current ambient atmospheric pressure, i.e. so as to supply superheated steam. The extra heat present within such steam (which is superheated but is not at substantially higher pressure than current ambient atmospheric pressure) will diffuse within the interior space of the envelope and will reboil the floating mist droplets.

Obviously in order to maintain the lift of this free balloon at a constant value the rate of reboiling of condensed hot water must be equal to the rate of condensation of water upon the inner skin of the envelope 1. However it is possible for the operator to vary the lift of this balloon in a manner analogous to the practice with a hot air balloon of the current conventional type: if the operator allows the reboiling rate of the boiler B to drop, so that the current rate of condensation of water is higher than the current rate of reboiling of water by the boiler B, then liquid water will start to progressively accumulate in the water reservoir WR and the balloon will start to progressively lose lift; while on the other hand, if the operator raises the current reboiling rate of the boiler B above the current rate of condensation of water, then the balloon will start to progressively gain lift, and this increasing of lift can continue while a sufficient quantity of water is available in the reservoir WR, and while sufficient room is available within the envelope 1.

The advantages and disadvantages of this third preferred embodiment free balloon which uses steam as lift gas are as follows.

Comparison with Hydrogen and Helium Balloons

The lifting performance provided by the steam used in this balloon is only about 60% that of hydrogen or helium, so that the present invention is markedly inferior in this regard. Moreover, it is necessary to provide the steam regeneration apparatus 5 merely to maintain lift, and this entails a weight penalty, while no corresponding apparatus is required in the case of hydrogen or helium. However, in the case of the present invention, buoyancy control is available, and this is an important beneficial feature. Furthermore, this balloon avoids the excessive danger of hydrogen and the excessive cost of helium. Yet further, as before, the great difficulty of providing helium in the field is completely eliminated, since in fact steam is even easier to produce locally than hydrogen.

Comparison with Hot Air Balloons

Again, the really significant comparison for this balloon according to the third preferred embodiment must be with a conventional hot air balloon which uses air heated by a propane burner as lift gas. The advantages of steam over heated air will be seen to be very notable. In order to focus the discussion, the case will again be considered of a balloon according to this third preferred embodiment whose envelope has a radius of 10 m, so that its volume (including the conical lower portion 1b) is about 4,500 m³ and its surface area is about 1,300 m².

Lift Comparison

In the conventional case of using heated air as the lift gas, as detailed previously, the maximum gross lift available even at the highest operationally acceptable lift air temperature of 120° C. will be about 14,355 newtons, so that the maximum gross mass that can be flown will be about 1,460 kg; and in fact the lift is usually substantially lower than this. On the other hand, with the use of steam as the lift gas, the gross lift is virtually doubled to about 28,170 newtons, which can fly a gross mass of about 2,870 kg. However, the advantage of the present invention over a conventional propane powered hot air balloon in terms of net lift, i.e. in terms of useful payload, is not as good as this, because allowance must be made for the following facts:

(1) In the case of the present invention, at any particular instant, a quantity of condensed liquid water is present within the envelope 1, some which has condensed in droplets upon the inner surface of the envelope 1 and is in the course of trickling down its inside, and some perhaps in mist form as described above. The weight of this condensed liquid water is entirely parasitic.

(2) The steam regeneration apparatus 5 of this third preferred embodiment will inevitably weigh more than does the typical set of propane burners and tanks used in a conventional hot air balloon.

The question therefore is as to how much extra mass will be entailed by these two considerations. It is not possible to put exact figures upon the masses involved without full scale implementation, which has not yet been performed.

However, with regard to point (1), experiments upon a small scale using a balloon fabric consisting of rip-stop nylon coated with a mixture of polyurethane and silicone have established that about 80 gm of water is adhering to and trickling down the inner surface of one square meter of the envelope at any time, on average; of course, the amount of this adhered trickling-down water varies with the slope of the portion in question of the envelope inner surface. It is believed that these experiments will scale quite accurately. Accordingly an upper limit for the mass of parasitic trickling-down water for the above described exemplary balloon is likely to be about 100 kg.

Furthermore, with regard to point (2), the present inventor does not believe that the extra weight entailed by a condensed water tank, a fuel reservoir, a boiler, and a burner, as opposed to propane tanks and a propane burner, could be more than about 300 kg. It might be much less. Furthermore, the longer the duration of the contemplated flight, the less does the weight penalty due to point (2) become, because (a) the calorific value of fuel oil (if this is used rather than solid fuel) per kilogram is greater than that of LPG; (b) the weight of tankage for storing a given mass of fuel oil is much less than the weight of the cylinders needed to contain the same mass of LPG (the weight of storage for solid fuel is even less, comparatively); and (c) as explained below, substantially less heat energy per hour will be required for maintaining the lift of this balloon, as compared to the case of a conventional hot air balloon.

Accordingly it is considered that this free balloon according to the third preferred embodiment which utilizes steam as lift gas will have greatly enhanced net lift, as compared to a similar sized balloon which utilizes heated air as lift gas. Or, to put it another way, for lifting the same net weight, if steam is used as the lift gas, a substantially smaller envelope will be required than in the case of heated air. In this case, the substantially reduced surface area of this substantially smaller envelope will further improve the fuel consumption even over the improved level that will be explained in the following.

Fuel Consumption Comparison

The temperature inside the envelope of this balloon according to the third preferred embodiment which uses steam as the lift gas is a uniform 100° C., and at sea level ISA the temperature of the outside air is 15° C., so that the temperature differential between the inside and outside of the envelope is about 85° C. On the other hand, in the case of a similarly sized conventional balloon which uses heated air as the lift gas, as described above the average temperature within the envelope needs to be kept at about 120° C. even to obtain merely half the gross lift of the balloon of the present invention, so that the temperature differential between the inside and outside of the envelope is about 105° C. Clearly, therefore, the rate of loss of heat in the case of the present invention will be substantially less than in the conventional prior art case where heated air is used as the lift gas. Of course in both cases the rate of heat loss must be balanced by the rate of consumption of fuel for reheating the lift gas, be it hot air or steam, and therefore it is considered that the fuel consumption per hour of operation of this balloon according to this third preferred embodiment of the present invention will be substantially less than that of a similarly sized conventional hot air balloon.

Now it is true that the boiler B will inevitably not be 100% efficient in boiling water, in other words that some heat will be wasted from the boiler B during the operation of this steam balloon. However, although the efficiency of the conventional method of heating the air within a conventional hot air balloon, which is to direct the flame from a LPG burner directly into the interior of the envelope through a hole in its bottom, appears to be quite good, actually this is not the case, since such a burner entrains a quantity of outside air from below into its exhaust gas stream (rather than using only air from within the envelope for combustion, which might be theoretically possible but actually is not practiced) and an equal compensating volume of air must accordingly be expelled from the downwardly facing mouth of the envelope. This displaced air is cooler than the target temperature of 120° C., but is not by any means cold, and in this manner a considerable amount of heat is wasted in the conventional case as well. The inefficiencies in both cases may be comparable; in fact, a boiler system is probably more efficient than a propane burner in terms of heat transfer to the lift gas.

In any case, even allowing for inefficiencies of the boiler, it is considered that this balloon according to this third preferred embodiment which utilizes steam as the lift gas will have much reduced fuel consumption, as compared to a similar sized balloon which utilizes heated air as the lift gas—and this even though the lift is greatly enhanced.

The Fourth Preferred Embodiment

Structure

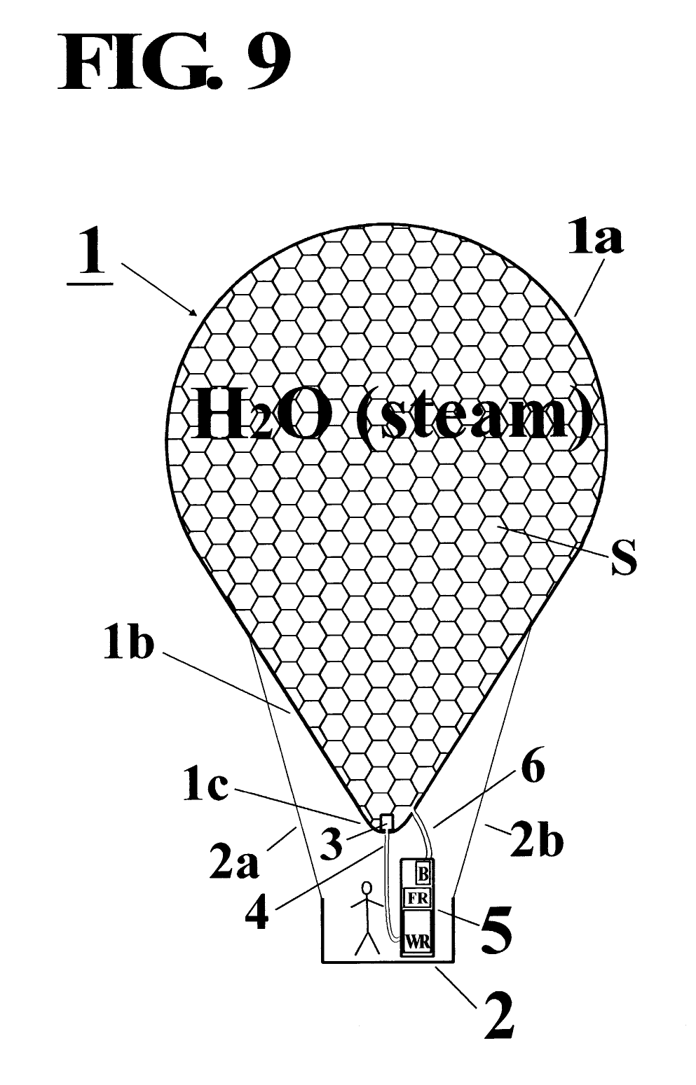

FIG. 9 is a schematic sectional view similar to FIGS. 2, 3, 6, and 8, showing a free balloon which is a fourth preferred embodiment of the present invention. In this figure, elements of the fourth preferred embodiment which correspond to elements of the first through third preferred embodiments shown in FIGS. 2 through 6 and which have the same functions are denoted by the same reference symbols, and the explanation of this fourth preferred embodiment will focus chiefly upon the features in which it differs from the first through third preferred embodiments described above, thus omitting repetitive matter. This fourth preferred embodiment is similar to the third preferred embodiment just described above, with the additional feature that the envelope 1 is covered over with slabs S of an insulation material. It is very desirable, and in fact almost mandatory, for these insulating material slabs S to be flexible, in order to allow for folding up of the envelope 1 after use. It is advantageous for them to be compressible without damage, in order to reduce the volume of the balloon envelope during transportation.

Benefits

Such flexible insulating slabs S can be extremely effective in reducing loss of heat from the steam within the envelope 1; depending upon their thickness and the material from which they are composed, it is considered that it would be possible to reduce heat loss, and accordingly fuel consumption, by a factor of 10 or more. The case will again be considered of the exemplary balloon discussed above whose envelope has a radius of 10 m, a volume of about 4,500 m³, and a surface area of about 1,300 m², in comparison with a similarly sized conventional hot air balloon. Since by using steam as lift gas rather than hot air the extra gross lift obtained is of the order of 14,000 newtons, it is clear that lifting a hypothetical additional mass of 500 kg of insulation upon the envelope 1 would use less than half of this extra gross lift. This allows for 380 grams of insulation to be mounted upon each square meter of the envelope fabric.

Reference is made to a material called “PrimaLoft” (which is a trademark) of which the main physical properties are described in U.S. Pat. Nos. 4,588,635 and 5,043,207. In particular, its thermal conductivity is about 0.28 BTU-in/ft².hr.°F and its density is about 8 kg/m³. The above area density of 380 g/m² therefore allows for a thickness of nearly 2 inches, so that the heat loss will be about 0.14 BTU/ft².hr.°F. (Actually, because the thermal conductivity above was measured by the plate-to-plate method, and in the case of a steam balloon there is a considerable further insulation effect due to a layer of heated air on the outside of the envelope, it is likely that the above figure is pessimistic). This heat loss rate translates to about 0.69 kCal/m². hr. °C. According to this specification, with an external temperature of 15° C., the heat loss per hour from the entire envelope of the exemplary balloon specified above would be 76 mCal, which would require the combustion of perhaps 8 kilograms of fuel to replace, allowing for inefficiencies in the boiler B. This is an extremely low fuel consumption for such a relatively large free balloon, and although the insulation value quoted above might be difficult completely to realize in practice, due to various factors, it is clear that the provision of insulation to the envelope can be very effective for reducing the rate of heat loss and accordingly the fuel consumption, at the cost of course of lower net lift and making the envelope 1 more difficult to handle upon the ground.

The Fifth Preferred Embodiment

Structure

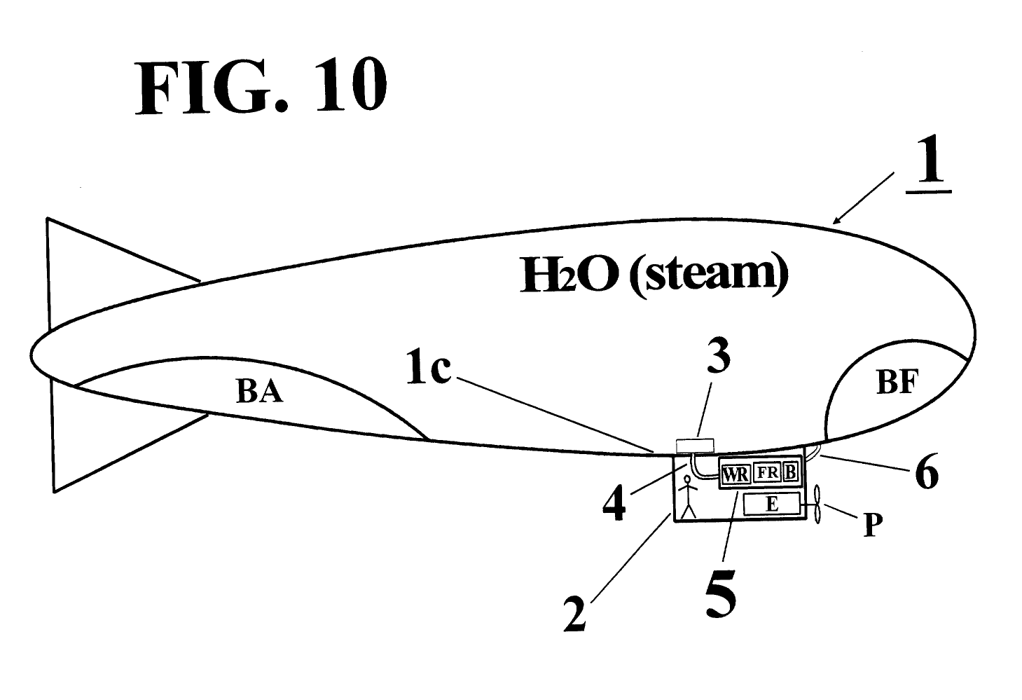

FIG. 10 is a vertical sectional view corresponding to FIG. 8 for the third preferred embodiment, showing a fifth preferred embodiment of the LTA craft of this invention. In this figure, elements of the fifth preferred embodiment which correspond to elements of the first through fourth preferred embodiments shown in FIGS. 2 through 9 and which have the same functions are denoted by the same reference symbols, and the explanation of this fifth preferred embodiment will focus chiefly upon the features in which it differs from the first through fourth preferred embodiments described above, thus omitting repetitive matter.

This fifth preferred embodiment is an airship of the non-rigid type whose envelope 1 has a generally conventional external shape, and a distinctive feature of this airship is that the lift gas utilized is steam. Another feature of this envelope 1 is that it incorporates a ballonet system which incorporates a fore ballonet designated as BF and an aft ballonet designated as BA, both of which are shown in FIG. 10 as fully inflated. It should be noted in this connection that, in contrast to the case with a conventional airship which uses a conventional lift gas such as hydrogen or helium, it is not required that the material of this envelope 1 should be completely impervious to the lift gas (steam in this case), since moderate leakage of this steam lift gas can be made good during flight. By contrast, of course, in the case of a conventional airship using hydrogen or helium as lift gas, replenishment of the lift gas during flight is quite impracticable, and accordingly the envelope of such a conventional airship is required to be substantially impermeable, which means that the material from which it becomes constructed is very expensive.

The lowermost portion of the envelope 1 is denoted by 1c, and a car 2 is fixed to the envelope 1 below this lowermost portion 1c. The car 2 comprises a steam regeneration apparatus 5 which is connected by a condensed water drain hose 4 to the lowermost envelope portion 1c, and which is further communicated to the envelope 1 by a steam supply hose 6, which passes through the envelope 1 at a position somewhat higher than the lowermost portion 1c, and which then opens within the envelope 1. And a condensed water drain valve 3, substantially identical to the valves 3 of the third and fourth preferred embodiments described above, is connected to the upper end of the condensed water drain hose 4 just within the envelope 1, and controls the communication between this hose 4 and the envelope 1, just as did the valves 3 of the third and fourth preferred embodiments, so as to allow liquid water accumulated in the lowermost portion 1c of the envelope 1 to be drained to the steam regeneration apparatus 5, while preventing any of the steam in the envelope 1 from escaping via this path. Additionally the car 2 comprises an engine E of a per se conventional type, such as an internal combustion engine like a gasoline or diesel engine, which drives a propeller P so as to propel this airship through the ambient air. The car 2 further comprises per se conventional means, not particularly shown in the figure or further described herein, for appropriately controlling supply of external air at appropriate pressure levels to the fore and aft ballonets BF and BA, and for appropriately controlling exhaust of air from these ballonets BF and BA.

The steam regeneration apparatus 5 of this fifth preferred embodiment operates in substantially the same manner as did the steam regeneration apparatus 5 of the third preferred embodiment, except that under the control of the operator it is capable of providing steam at a somewhat greater pressure than that of the ambient atmosphere.

Operation

This airship is operated as will now be described.

Again, for the same reasons as before, for initial inflation on the ground from the collapsed condition it is contemplated that the boiler B in the steam regeneration apparatus 5 will not ordinarily be used. Instead, steam for initial ground inflation of the envelope 1 will typically be provided from an external steam supply means (not particularly shown) like the steam truck T described above. In the case of this fifth preferred embodiment which incorporates the fore and aft ballonets BF and BA, before takeoff, first these ballonets should be charged with appropriate amounts of air (in fact, at ground level, the ballonets should be almost or completely filled), and then the main volume of the envelope 1 (not including the ballonets BF and BA) should be completely filled with steam, and should be pressurized to an appropriate pressure level somewhat higher than the external atmospheric pressure, so that the envelope 1 is somewhat distended with positive pressure and is thereby made rigid. When the envelope 1 is thus appropriately charged, this airship may be released to commence flight. Optionally and desirably, some reserve water may be stored in the water reservoir WR before takeoff.

As in the case of the previously described preferred balloon embodiments of the present invention, as soon as steam is supplied into the envelope 1, water droplets will start condensing upon the inner envelope surface due to the loss of heat to the outside atmosphere through the material of the envelope 1, and these water droplets will start trickling downwards to the lowest envelope portion 1c. Thus water at a temperature of substantially 100° C. will start accumulating in this portion 1c and, as explained above with reference to the third preferred embodiment of the present invention, this hot water will drain via the condensed water drain valve 3 and the drain hose 4 into the hot water reservoir WR of the steam regeneration apparatus 5.

In order to maintain the lift of this airship, and also in order to maintain the positive pressure differential which ensures its rigidity, drained hot water in the reservoir WR should be reboiled. The operator does this by operating the boiler B, which converts the desired amount of the hot water in the reservoir WR into steam which is supplied via the steam supply hose 6 back to the interior space within the envelope 1. As in the case of the third preferred embodiment, it may in some circumstances be advantageous for the operator so to control the steam regeneration apparatus 5 as to supply steam to within the envelope 1 at a temperature higher than the boiling point of water at the current ambient pressure, i.e. so as to supply superheated steam. In order to reconvert water droplets floating as mist within the interior of the envelope 1 back into steam.

As in the case of the third preferred balloon embodiment, it is possible for the operator to vary the lift of this airship. If the operator allows the reboiling rate of the boiler B to drop, so that the rate of condensation of water upon the inside of the envelope 1 is higher than the rate of reboiling of water by the boiler B, then the quantity of steam within the envelope 1 will start progressively decreasing, so that the airship will start progressively losing lift. At this time extra air should be progressively supplied into the ballonets BF and BA so as to maintain a proper pressure differential between the interior of the envelope 1 and the outside atmosphere in order to maintain rigidity of the envelope 1 as a whole. This can continue while sufficient extra water storage capacity is available in the reservoir WR (although water could be discharged overboard if deemed operationally advisable), and while extra room for air is available within the ballonets BF and BA. Moreover during this process advantage can be taken to some extent of the elasticity of the material of the envelope 1 by allowing the pressure differential to decrease down to a certain acceptable lower limit dictated by the requirement for envelope rigidity, thus allowing the material of the envelope 1 to contract somewhat so that the volume of the envelope 1 decreases and accordingly its gross lift decreases. On the other hand, if the operator raises the reboiling rate of the boiler B above the rate of condensation of water on the inside of the envelope 1, then the quantity of steam within the envelope 1 will start progressively increasing, so that the airship will start progressively gaining lift. At this time air should be progressively exhausted from the ballonets BF and BA, so as to maintain the proper pressure differential for maintaining rigidity of the envelope 1. This can continue while a sufficient quantity of water is available in the reservoir WR, and until the ballonets BF and BA become completely collapsed. Moreover during this process advantage can be taken to some extent of the elasticity of the material of the envelope 1 by allowing the pressure differential to increase up to a certain acceptable upper limit dictated by the requirement for envelope integrity, thus causing the material of the envelope 1 to be somewhat stretched so that the volume of the envelope 1 increases and accordingly its gross lift increases.

Furthermore, if during flight it is found that this airship is becoming unduly light, presumably due to progressive consumption of fuel, and it is desired to reduce the lift without altering the amount of air in the ballonets BF and BA, then it is perfectly practicable to vent some of the steam lift gas within the envelope 1 and to replace it by pumping in a corresponding volume of atmospheric air. This action cannot be reversed during flight, because the only way to eliminate all air in the envelope 1 would be to deflate it completely and then to reinflate it with steam, and of course this can only be done upon the ground. However, it may be a useful procedure in certain operational circumstances.

Benefits

The advantages and disadvantages of this fifth preferred airship embodiment of the present invention which uses steam as lift gas are as follows. Airships which utilize heated air as lift gas are not considered by the present applicant as serious aircraft, due to their floppiness, and hydrogen is not used for airships nowadays due to the danger which it poses, so only a comparison with a pressurized airship which uses helium as a lift gas will be made.

The lifting performance provided by the steam used as lift gas in this airship is only about 60% that of helium, so that this airship according to the fifth preferred embodiment of the present invention is markedly inferior in this regard to a helium airship. Moreover, it is necessary to provide the steam regeneration apparatus 5 to maintain lift, while no corresponding apparatus is required in the case of helium. Accordingly for the same net lift, i.e. for the same payload, the volume required for an airship according to the present invention employing steam as lift gas will be about twice that of a comparison airship which employs helium. Therefore its surface area will be about 2^{2/3} times, i.e. about 1.6 times, that of the comparison helium airship, and it is expected that the energy required for propulsion, i.e. the fuel consumption of the engine E, will be likewise increased. However the cost of manufacture of the envelope should actually be less for this steam airship than for a helium airship of equivalent lift, although this steam airship is larger, because there is no requirement for complete impermeability to the lift gas; moderate percolation of steam through the envelope will prove of little consequence operationally, and accordingly a much cheaper material can be used for manufacturing the envelope.

In the case of the present invention buoyancy control for the airship is available in various different manners as described above, and this is an important benefit. This could be of great use in the case of embodying the present invention as a very large airship intended for transport of heavy cargo. However, the most significant advantage of this airship according to this fifth preferred embodiment of the present invention is in operational cost, because the excessive cost of helium is entirely avoided. The difficulty of providing helium in the field is also eliminated.

An extremely beneficial consequence of the fact that the steam lift gas for this airship is extremely cheap and easily produced is that the operator, if he deems it operationally desirable, need feel no concern about ripping the envelope so as to vent the lift gas. In fact it is quite feasible for the envelope to be ripped at the end of every flight. This is completely impracticable due to cost considerations in the prior art case of helium lift gas. Alternatively, the boiler B may be deactivated at the end of the flight and the envelope may be left to collapse gradually by itself as the steam within condenses. In either of these cases storage of the airship on the ground is greatly facilitated, as compared to the case of a helium airship which must be stored in the inflated condition. However with this fifth preferred embodiment airship, if so required, the steam within the envelope could be kept in vapor form until the next flight for a quite modest expenditure, even over a period of weeks.

A Note Upon Safety of a Steam Airship

The use of steam as lift gas in this airship presents no substantial safety problem while the envelope 1 is being charged and during flight. However, if as described above the envelope is ripped upon landing, there might be a substantial risk of scalding to the operator, because when the envelope of an airship is ripped it settles all around the car or just to one side thereof, in contrast to the case with a free balloon in which the envelope settles a certain distance downwind of the basket.

An operational procedure which can prevent such risk is as follows. The ripping procedure should be performed in two stages. In a first ripping stage, just before landing or upon landing, the pilot should cause a moderate rip perhaps 50 centimeters long or so to be formed at the top of the envelope 1, and simultaneously he should deploy a high capacity air blower (not shown in the figures) so as to blow a strong flow of atmospheric air into the envelope from below. The steam in the envelope will therefore vent upwards rapidly and harmlessly, while the envelope remains taut and elevated above the car as its contents quickly become replaced by atmospheric air. Of course during this process the lift provided by the envelope drops rapidly to zero, so that the airship rapidly becomes firmly grounded. When substantially all of the steam has been vented, so that no further danger of scalding is present, then in a second ripping stage the pilot should stop the operation of the blower and simultaneously should cause a much longer rip to be formed in the envelope, so that the air which it contains (which will be fairly warm and buoyant because of being admixed with a residual amount of condensed steam) will be vented all at once. At this time the envelope will naturally settle down all around the car or just to one side thereof, but this will be quite safe because its heat capacity, and the heat capacity of residual warm air remaining in it, are very low.

A suitable means for ripping the envelope 1 in these two stages might incorporate pieces of resistance wire (such as nichrome wire) embedded in or attached to the envelope. For each stage of ripping, the pilot would cause voltage to be applied to an appropriate portion of this wire, which would then heat up and melt through the material of the envelope along a suitably defined appropriate path. It would be convenient for the portions of the envelope proximate to the wire to be made easily replaceable, so that the integrity of the envelope can be easily restored for the next flight. Optionally these envelope portions could be made as zip-in portions. No drawing is provided to show this suggested arrangement, because based upon the above description a person of ordinary skill in the art will be easily able to understand the concept without any figure.

The Sixth Preferred Embodiment

Structure

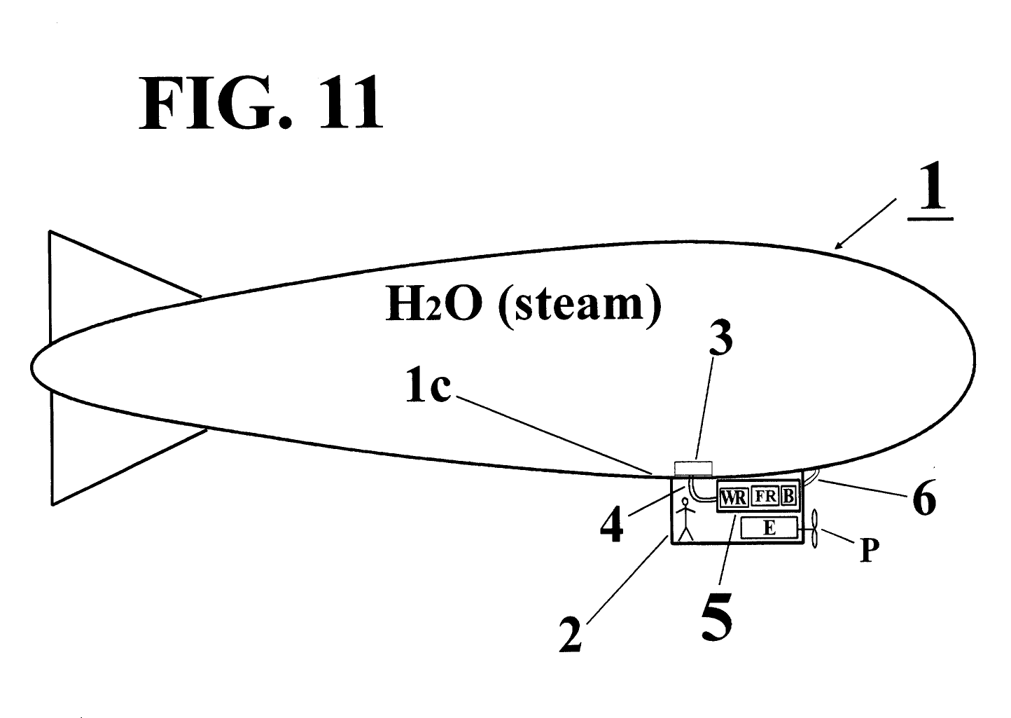

FIG. 11 is a vertical sectional view corresponding to FIG. 10 for the fifth preferred embodiment, showing a sixth preferred embodiment of the LTA craft of this invention. In this figure, elements of the sixth preferred embodiment which correspond to elements of the fifth preferred embodiment shown in FIG. 10 and which have the same functions are denoted by the same reference symbols, and the explanation of this sixth preferred embodiment will focus chiefly upon the features in which it differs from the fifth preferred embodiment described above, thus omitting repetitive matter.

This sixth preferred embodiment again is an airship of the non-rigid type whose envelope 1 has a generally conventional external shape, and a distinctive feature of this airship is that the lift gas utilized is steam. However the feature of this sixth preferred embodiment which distinguishes it from the fifth preferred embodiment described above is that its envelope 1 incorporates no ballonet. Furthermore, the envelope 1 is made to be elastic.

As with the fifth preferred embodiment, a car 2 is fixed to the envelope 1. The details of the car 2 and of the steam regeneration apparatus 5 which it incorporates are substantially the same as in the fifth preferred embodiment described above, and accordingly their description will be curtailed.

Operation

This sixth preferred embodiment airship is operated as will now be described.

Again, for the same reasons as before, for initial inflation on the ground from the collapsed condition it is contemplated that the boiler B in the steam regeneration apparatus 5 will not ordinarily be used. Instead, steam for initial ground inflation of the envelope 1 will typically be provided from an external steam supply means (not particularly shown) like the steam truck T described above with regard to the operation of the first preferred embodiment. In the case of this sixth preferred embodiment, the envelope 1 should be completely filled with steam before takeoff, and should be pressurized to a desired pressure level somewhat higher than the external atmospheric pressure, so that it is somewhat distended with positive pressure against the force of its elasticity, and is thereby made rigid. When the envelope 1 is appropriately charged, this airship may be released to commence flight. Optionally and desirably, some reserve water may be stored in the water reservoir WR before takeoff.

As in the case of the other preferred embodiments described above, as soon as steam is supplied into the envelope 1, water droplets will start condensing upon the inner envelope surface due to the loss of heat to the outside atmosphere through the material of the envelope 1, and these water droplets will start trickling downwards to the lowest envelope portion 1c. Thus water at a temperature of substantially 100° C. will start accumulating in this portion 1c and, as explained above, this hot water will drain via the condensed water drain valve 3 and the drain hose 4 into the hot water reservoir WR of the steam regeneration apparatus 5.

Drained hot water in the reservoir WR must be reboiled in order to maintain the lift of this airship, and also in order to maintain the positive pressure differential which ensures its rigidity between its upper pressure limit (defined by the requirement not to overstretch the envelope 1) and its lower pressure limit (defined by the requirement to maintain a certain degree of envelope rigidity). The operator does this by operating the boiler B, which converts the appropriate amount of the hot water in the reservoir WR into steam which is supplied via the steam supply hose 6 back to the interior space within the envelope 1. As in the case of the third through the fifth preferred embodiments, it may in some circumstances be advantageous for the operator so to control the steam regeneration apparatus 5 as to supply steam to within the envelope 1 at a temperature higher than the boiling point of water at the current ambient pressure, i.e. so as to supply superheated steam, in order to reconvert water droplets floating as mist within the interior of the envelope 1 into steam.

Thus, in this sixth preferred embodiment, the envelope 1 has been greatly simplified in that no ballonet has been incorporated, and this also simplifies the operation of the airship in that no pressure fan for ballonet pressurization needs to be operated or monitored, and these are notable advantages. However, as described above, it is required that the operator should increase or decrease the rate at which the steam regeneration apparatus reboils the water in the water reservoir WR in accordance with the trend of the pressure differential, which can vary due to change of the external atmospheric pressure caused by change of altitude of the airship or by the weather, or due to insolation, so as on the one hand to avoid damage being caused to the envelope 1 by over-pressure, while on the other hand avoiding the envelope 1 sagging or becoming floppy due to under-pressure. A high elasticity for the envelope 1 will materially aid in this pressure control by allowing more latitude to the lift gas (steam) to expand and contract without much varying the pressure differential; and, of course, the relaxation of the prior art requirement for the envelope to be absolutely impermeable to the lift gas makes it easier to select a material for the envelope 1 which can be sufficiently elastic without being unduly expensive.

As in the case of the fifth preferred embodiment described above, it is possible for the operator to vary the lift of this airship, but in a somewhat different manner, as follows. If the operator allows the reboiling rate of the boiler B to drop, so that the rate of condensation of water upon the interior surface of the envelope 1 is higher than the rate of reboiling of water by the boiler B, then the pressure of the steam within the envelope 1 will start dropping and the envelope 1 will start shrinking due to its elasticity, so that the airship will start losing lift. At this time the pressure differential between the interior of the envelope 1 and the external atmosphere will naturally be dropping, and it is incumbent upon the operator to ensure that it does not drop so far as to compromise the required rigidity of the envelope 1. On the other hand, if the operator raises the reboiling rate of the boiler B above the rate of condensation of water upon the interior surface of the envelope 1, then the pressure of the steam within the envelope 1 will start rising and the envelope 1 will start being expanded against the force of its elasticity, so that the airship will start gaining lift. At this time the pressure differential between the interior of the envelope 1 and the external atmosphere will be rising and the stretching (strain) of the envelope 1 will be increasing, and it is incumbent upon the operator to ensure that the envelope 1 is not stretched so far as to damage it; in other words, he must ensure that the elastic limit of the material of the envelope 1 is not surpassed at any point of its surface along any direction. Again, a high elasticity for the envelope 1 will materially aid in this lift control by allowing more latitude for change of volume relative to variation of the pressure differential. Particularly, it will be beneficial for the envelope material to be more elastic in the longitudinal direction of the airship, than in its circumferential direction.

As with the airship according to the fifth preferred embodiment of the present invention described above, if during flight it is found that this sixth preferred embodiment airship is becoming unduly light due to progressive consumption of fuel, it is quite practicable in some circumstances to vent some of the steam lift gas within the envelope 1 and to replace it by pumping in a corresponding volume of atmospheric air.

The advantages and disadvantages of this airship which uses steam as lift gas are similar to those of the fifth preferred embodiment, with the additional benefit that no ballonet needs to be provided and no ballonet management needs to be performed. This concept has a particular synergy with the concept of using steam as the lift gas, since only when steam is used as the lift gas is it possible in practice to provide additional lift gas to the airship envelope during flight, or to temporarily withdraw lift gas from the envelope during flight with the possibility of replacing it.

Disclaimer

Although the present invention has been shown and described with reference to various embodiments thereof, the form and the details of any particular embodiment could be varied without departing from the scope of the invention. The concepts of the various embodiments could also be combined in various ways. Accordingly it is desired that the scope of the present invention should be determined, not by any of the perhaps purely fortuitous details of particular embodiments, but solely by the claims.

1. A method for operating a lighter than air craft comprising an envelope which comprises an interior filled with a lift gas which contains a substantial proportion of steam, comprising processes of:
passing liquid water accumulating at a low point of said interior of said envelope out from said envelope and discharging said passed out liquid water into the atmosphere;
storing ballast; and:
discharging said ballast into the atmosphere.

2. A method for operating a lighter than air craft according to claim 1, further comprising a process of manually bringing the ballast discharge mass rate at which said ballast is discharged into the atmosphere to be, at each instant, approximately equal to the water discharge mass rate at which said passed out water is discharged into the atmosphere.

3. A method for operating a lighter than air craft according to claim 1, further comprising a process of automatically bringing the ballast discharge mass rate at which said ballast is discharged into the atmosphere to be, at each instant, approximately equal to the water discharge mass rate at which said passed out water is discharged into the atmosphere.

4. A method for operating a lighter than air craft according to claim 2, further comprising a process of manually varying said ballast discharge mass rate within a certain range around said water discharge mass rate.

5. A method for operating a lighter than air craft according to claim 3, further comprising a process of manually varying said ballast discharge mass rate within a certain range around said water discharge mass rate.

6. A method for operating a lighter than air craft according to claim 1, wherein said ballast is water.

7. A method for operating a lighter than air craft according to claim 2, wherein said ballast is water.

8. A method for operating a lighter than air craft according to claim 3, wherein said ballast is water.

9. A method for operating a lighter than air craft according to claim 4, wherein said ballast is water.

10. A method for operating a lighter than air craft according to claim 5, wherein said ballast is water.

11. A lighter than air craft comprising:
an envelope which comprises an interior;
means for passing liquid water accumulating at a low point of said interior of said envelope out from said envelope and for discharging said passed out liquid water into the atmosphere;
means for storing ballast; and:
means for discharging ballast from said storage means into the atmosphere.

12. A lighter than air craft according to claim 11, further comprising means for manually controlling said ballast discharge means so as to bring the ballast discharge mass rate at which it discharges said ballast into the atmosphere to be, at each instant, approximately equal to the water discharge mass rate at which said water discharge means is currently discharging said passed out water into the atmosphere.

13. A lighter than air craft according to claim 11, further comprising means for automatically controlling said ballast discharge means so as to bring the ballast discharge mass rate at which it discharges said ballast into the atmosphere to be, at each instant, approximately equal to the water discharge mass rate at which said water discharge means is currently discharging said passed out water into the atmosphere.

14. A lighter than air craft according to claim 12, wherein said ballast discharge control means is further manually controllable so as to vary said ballast discharge mass rate within a certain range around said water discharge mass rate.

15. A lighter than air craft according to claim 13, wherein said ballast discharge control means is further manually controllable so as to vary said ballast discharge mass rate within a certain range around said water discharge mass rate.

16. A lighter than air craft according to claim 11, wherein said ballast is water, and said ballast discharge means is a water flow control valve.

17. A lighter than air craft according to claim 12, wherein said ballast is water, and said ballast discharge means is a water flow control valve.

18. A lighter than air craft according to claim 13, wherein said ballast is water, and said ballast discharge means is a water flow control valve.

19. A lighter than air craft according to claim 14, wherein said ballast is water, and said ballast discharge means is a water flow control valve.

20. A lighter than air craft according to claim 15, wherein said ballast is water, and said ballast discharge means is a water flow control valve.

21. A lighter than air craft comprising:
an envelope which comprises an interior filled with a lift gas which contains a substantial proportion of steam;
means for passing liquid water accumulating at a low point of said interior of said envelope out from said envelope and for discharging said passed out liquid water into the atmosphere;
means for storing ballast; and:
means for discharging ballast from said storage means into the atmosphere.

22. A lighter than air craft according to claim 21, further comprising means for manually controlling said ballast discharge means so as to bring the ballast discharge mass rate at which it discharges said ballast into the atmosphere to be, at each instant, approximately equal to the water discharge mass rate at which said water discharge means is currently discharging said passed out water into the atmosphere.

23. A lighter than air craft according to claim 21, further comprising means for automatically controlling said ballast discharge means so as to bring the ballast discharge mass rate at which it discharges said ballast into the atmosphere to be, at each instant, approximately equal to the water discharge mass rate at which said water discharge means is currently discharging said passed out water into the atmosphere.

24. A lighter than air craft according to claim 22, wherein said ballast discharge control means is further manually controllable so as to vary said ballast discharge mass rate within a certain range around said water discharge mass rate.

25. A lighter than air craft according to claim 23, wherein said ballast discharge control means is further manually controllable so as to vary said ballast discharge mass rate within a certain range around said water discharge mass rate.

26. A lighter than air craft according to claim 21, wherein said ballast is water, and said ballast discharge means is a water flow control valve.

27. A lighter than air craft according to claim 22, wherein said ballast is water, and said ballast discharge means is a water flow control valve.

28. A lighter than air craft according to claim 23, wherein said ballast is water, and said ballast discharge means is a water flow control valve.

29. A lighter than air craft according to claim 24, wherein said ballast is water, and said ballast discharge means is a water flow control valve.

30. A lighter than air craft according to claim 25, wherein said ballast is water, and said ballast discharge means is a water flow control valve.

31. A lighter than air craft comprising:
an envelope comprising an interior; and
means for passing liquid water accumulating at a low point of said interior of said envelope out from said interior of said envelope, while intercepting gas from passing out from said interior of said envelope to the outside and intercepting gas from passing in from the outside to said interior of said envelope.

32. A lighter than air craft according to claim 31, wherein said water passing and gas intercepting means comprises a trap valve comprising a valve seat and a valve float, said valve float: when less than a predetermined level of liquid water is present around it, sinking therein and resting against and intercepting said valve seat and preventing the passage of liquid water and of gas through said valve seat; and, when more than said predetermined level of liquid water is present around it, floating upward therein and rising away from and opening said valve seat and allowing the passage of liquid water through said valve seat while said liquid water intercepts the passage of gas through said valve seat.

33. A lighter than air craft, comprising:
an envelope which comprises an interior;
means for collecting liquid water accumulating at a low point of said interior of said envelope; and:
means for boiling said collected liquid water into steam and for supplying said steam into said envelope, whose rate of boiling operation is variable.

34. A lighter than air craft as claimed in claim 33, further comprising means for at least temporarily storing at least a portion of said accumulated liquid water, before supply thereof to said boiling means.

35. A lighter than air craft, comprising:
an envelope which comprises an interior;
means for collecting liquid water accumulating at a low point of said interior of said envelope;
means for storing liquid water, which receives said liquid water from said water collecting means; and:
means for boiling liquid water from said water storing means into steam and for supplying said steam into said envelope, whose rate of boiling operation is variable.

36. A lighter than air craft, comprising:
an envelope which comprises an interior filled with a lift gas which contains a substantial proportion of steam;
means for collecting liquid water accumulating at a low point of said interior of said envelope; and:
means for boiling said collected liquid water into steam and for supplying said steam into said envelope, whose rate of boiling operation is variable.

37. A lighter than air craft as claimed in claim 36, further comprising means for at least temporarily storing at least a portion of said accumulated liquid water, before supply thereof to said boiling means.

38. A lighter than air craft, comprising:
an envelope which comprises an interior filled with a lift gas which contains a substantial proportion of steam;
means for collecting liquid water accumulating at a low point of said interior of said envelope;
means for storing liquid water, which receives said liquid water from said water collecting means; and:
means for boiling liquid water from said water storing means into steam and for supplying said steam into said envelope, whose rate of boiling operation is variable.
